(19) United States
(12) Patent Application Publication
(10) Pub. No.: US 2006/0261508 A1
(43) Pub. Date: Nov. 23, 2006

(54) Fiber reinforced polypropylene composite headliner substrate panel

(76) Inventors: Arnold Lustiger, Edison, NJ (US); Jeffrey Valentage, Royal Oak, MI (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 11/433,207

(22) Filed: May 12, 2006

Related U.S. Application Data
(63) Continuation-in-part of application No. 11/395,493, filed on Mar. 31, 2006.
Application No. 11/395,493 is a continuation-in-part of application No. 11/387,496, filed on Mar. 23, 2006.
Application No. 11/387,496 is a continuation-in-part of application No. 11/318,363, filed on Dec. 23, 2005.
Application No. 11/318,363 is a continuation-in-part of application No. 11/301,533, filed on Dec. 13, 2005.
(60) Provisional application No. 60/681,609, filed on May 17, 2005.

(51) Int. Cl. C08K 3/30; B29C 47/60; B29C 51/00

(52) U.S. Cl. 264/140; 524/425; 524/487; 524/451; 524/445; 524/502; 524/449; 524/423; 524/432; 264/211; 264/544; 264/546; 264/211.23

(57) ABSTRACT

A fiber reinforced polypropylene composite headliner substrate panel. The headliner substrate panel is molded from a composition comprising at least 30 wt % polypropylene based resin, from 10 to 60 wt % organic fiber and from 0 to 40 wt % inorganic filler, based on the total weight of the composition, the headliner substrate panel having an outer surface and an underside surface. A process for producing a headliner substrate panel for a vehicle is also provided. The process includes the step of molding a composition to form the composite headliner substrate panel, the headliner substrate panel having at least an outer surface and an underside surface, wherein the composition comprises at least 30 wt % polypropylene, from 10 to 60 wt % organic fiber and from 0 to 40 wt % inorganic filler, based on the total weight of the composition.

### CROSS-REFERENCE TO RELATED APPLICATIONS

This application is a Continuation-in-Part of U.S. patent application Ser. No. 11/395,493 filed Mar. 31, 2006, which is a Continuation-in-Part of U.S. patent application Ser. No. 11/387,496, filed Mar. 23, 2006, which is a Continuation-in-Part of U.S. patent application Ser. No. 11/318,363, filed Dec. 23, 2005, which is a Continuation-in-Part of U.S. patent application Ser. No. 11/301,533, filed Dec. 13, 2005, and claims priority of U.S. Provisional Application Ser. No. 60/681,609, filed May 17, 2005, the contents of each are hereby incorporated by reference.

### FIELD OF THE INVENTION

The present invention is directed generally to automotive interior headliner substrate panels and the like produced from fiber reinforced polypropylene compositions. The present invention is also directed to the molding of automotive interior headliner substrate panels produced from fiber reinforced polypropylene compositions.

### BACKGROUND OF THE INVENTION

Inflatable airbags have been well accepted for use in motor vehicles and have been credited with preventing numerous deaths and injuries. Some statistics estimate that frontal airbags reduce fatalities in head-on collisions by 25% among drivers using seat belts and by more than 30% among unbelted drivers. Statistics further suggest that with a combination of seat belt and airbag, serious chest injuries in frontal collisions can be reduced by 65% and serious head injuries by up to 75%. The inclusion of inflatable airbags is now a legal requirement for many new vehicles.

A modern airbag system may include an electronic control unit (ECU) and one or more airbag modules. The ECU is usually installed in the middle of an automobile, between the passenger and engine compartments. The ECU includes a sensor which continuously monitors the acceleration and deceleration of the vehicle and sends this information to a processor that utilizes an algorithm to determine if the vehicle is in an accident situation.

When the processor determines that there is an accident situation, the ECU transmits an electrical current to an initiator in the airbag module. The initiator triggers operation of the inflator or gas generator which, in some embodiments, uses a combination of compressed gas and solid fuel. The inflator inflates a textile airbag that protects a passenger during impact to prevent injury to the passenger. In some airbag systems, the airbag may be fully inflated within 50 thousandths of a second and deflated within two tenths of a second.

Airbag systems have been primarily designed for deployment in front of an occupant, between the upper torso and head of an occupant and the windshield or instrument panel. Conventional airbags, such as driver or passenger airbags, protect the occupant's upper torso and head from colliding with a windshield or instrument panel. Such conventional airbag modules for frontal occupant protection deploy from the instrument panel or the steering wheel. The conventional location of these airbags has several disadvantages including poor protection for out-of-position occupants and unaesthetic tear seams on the instrument panel or steering wheel.

Airbag technology has advanced to include airbag systems that protect occupants during a side impact or roll-over accident. In these accidents, the occupant may be thrown against the windows, doors and side-walls of the vehicle. These airbag systems are known as curtain airbags. Generally, the curtain airbag is attached to a thin long frame member that runs along a side of the roof of the vehicle.

Typically, the airbag of a curtain airbag system inflates and descends from the frame member to cover a majority of the area between the occupant and the side of the vehicle interior. The inflated airbag appears much like a curtain covering the vehicle window. The curtain airbag may protect the occupant from impact with a side window, flying shards of glass, and other projectiles. The curtain airbag may also serve to keep the occupant inside the vehicle during a roll-over accident.

Further advancements in airbag technology have also yielded overhead airbag systems. Overhead airbags can provide better protection for out-of-position vehicle occupants and avoid the necessity of installing airbags in the vehicle instrument panel. As may be appreciated, overhead airbags systems must be designed to avoid the tendency to deploy in a manner such that roof elements, such as the headliner or sun visor, are fractured and/or propelled toward the vehicle occupants or in a direction in which they can impede inflation of the airbag.

Generally, the overhead airbag is installed in a very limited space. The inflator may be a thin, cylindrical member that extends over a portion of the length of the overhead airbag. In this manner, the overhead airbag inflator is capable of providing sufficient inflation gas to properly inflate the overhead airbag. The gas is often created from the rapid burning of pyrotechnic materials. The gas escapes exit ports in the inflator at a high velocity and temperature. Due to the limited space, the textile airbag is often stored by folding against the inflator.

A headliner panel is frequently employed to cover the compartment containing the overhead airbag. The headliner panel can be made by several techniques: extruded rigid plastic sheets thermoformed in to the applicable geometry with a cloth covering to provide an aesthetically pleasing appearance, compressed rigid fiber board (wood or other natural products) that is formed into the applicable shape with a cloth covering to provide an aesthetically pleasing appearance, injection/compression molding a rigid plastic that is formed into the applicable geometry with cloth covering to provide an aesthetically pleasing appearance, or any of the above manufacturing techniques along with separately manufactured and attached injection and/or blow-molded components such as supports, rib sections, air-distribution channels, mounts, etc. These components can be attached be any number of means such as glue, welding, screws, rivets, etc. The headliner is forced to open by the pressure of the deploying airbag in the region of the overhead airbag module compartment. In deploying the airbag, it is preferable to retain the headliner panel to prevent any portion of the headliner from flying loose in the passenger compartment. If the headliner panel is severed or otherwise freely moves into the passenger compartment, it may injure a passenger. Also, to insure there will be no flying fragments ejected into the passenger compartment a cloth “scrim” may be required on the back of the headliner panel to keep in fragments in place.

In the molding of automobile parts, such as headliner panels, injection molding, thermoforming, blow molding, injection/compression, and compression molding processes have been employed. Injection molding of thermoplastic resin has been used for many small articles. Thermosetting polyester filled with chopped fibers has been compression molded into relatively large sheets or panels. Despite attempts to produce headliner substrate panels having a high quality surface finish, the surface finish obtained has not been particularly good.

Glass reinforced polypropylene compositions have been introduced to improve stiffness. However, the glass fibers have a tendency to break in typical molding equipment, resulting in reduced toughness and stiffness. In addition, glass reinforced products have a tendency to warp.

Thermoplastic resins employing glass fibers have been extruded in sheet form. Glass fibers have also been used as a laminate in thermoplastic resin sheet form. The sheets can then be thermoformed or compression molded to a particular shape. As may be appreciated by those skilled in the art, compression molding has certain limitations since compression molded parts cannot be deeply drawn and thus must possess a relatively shallow configuration. Additionally, such parts are not particularly strong and require structural reinforcements when used in the production of relatively large panels. Moreover, the surface finish of glass-filled resins is generally poor.

The automotive industry generally requires that all surfaces visible to the consumer have “class A” surface quality. Components made of glass-filled compositions often require extensive surface preparation and the application of a coating or other covering to provide a surface of acceptable quality and appearance. The steps required to prepare such a surface may be expensive and time consuming and may affect mechanical properties.

All headliners are covered with some type of woven or non-woven cloth to hide the poor surface appearance of the substrate. The addition of a cloth look concentrate would eliminate the need for the covering altogether or if the PET fiber is colored darker than the base resin color this would create a cloth look with any additional fibers/fillers added (example dark gray PET fibers with a light gray base polymer).

As an alternative to the use of glass fibers, another known method of improving the properties of polyolefins is organic fiber reinforcement. For example, EP Patent Application No. 0397881, the entire disclosure of which is hereby incorporated herein by reference, discloses a composition produced by melt-mixing 100 parts by weight of a polypropylene resin and 10 to 100 parts by weight of polyester fibers having a fiber diameter of 1 to 10 deniers, a fiber length of 0.5 to 50 mm and a fiber strength of 5 to 13 g/d, and then molding the resulting mixture. Also, U.S. Pat. No. 3,639,424 to Gray, Jr. et al., the entire disclosure of which is hereby incorporated herein by reference, discloses a composition including a polymer, such as polypropylene, and uniformly dispersed therein at least about 10% by weight of the composition staple length fiber, the fiber being of man-made polymers, such as poly(ethylene terephthalate) (PET) or poly(1,4-cyclohexylenedimethylene terephthalate).

Fiber reinforced polypropylene compositions are also disclosed in PCT Publication WO 02/053629, the entire disclosure of which is hereby incorporated herein by reference. More specifically, WO 02/053629 discloses a polymeric compound, comprising a thermoplastic matrix having a high flow during melt processing and polymeric fibers having lengths of from 0.1 mm to 50 mm. The polymeric compound comprises between 0.5 wt % and 10 wt % of a lubricant.

Various modifications to organic fiber reinforced polypropylene compositions are also known. For example, polyolefins modified with maleic anhydride or acrylic acid have been used as the matrix component to improve the interface strength between the synthetic organic fiber and the polyolefin, which was thought to enhance the mechanical properties of the molded product made therefrom.

Other background references include PCT Publication WO 90/05164; EP Patent Application 0669372; U.S. Pat. No. 6,395,342 to Kadowaki et al.; EP Patent Application 1075918; U.S. Pat. No. 5,145,891 to Yasukawa et al.; U.S. Pat. No. 5,145,892 to Yasukawa et al.; and EP Patent 0232522, the entire disclosures of which are hereby incorporated herein by reference.

U.S. Pat. No. 3,304,282 to Cadus et al. discloses a process for the production of glass fiber reinforced high molecular weight thermoplastics in which the plastic resin is supplied to an extruder or continuous kneader, endless glass fibers are introduced into the melt and broken up therein, and the mixture is homogenized and discharged through a die. The glass fibers are supplied in the form of endless rovings to an injection or degassing port downstream of the feed hopper of the extruder.

U.S. Pat. No. 5,401,154 to Sargent discloses an apparatus for making a fiber reinforced thermoplastic material and forming parts therefrom. The apparatus includes an extruder having a first material inlet, a second material inlet positioned downstream of the first material inlet, and an outlet. A thermoplastic resin material is supplied at the first material inlet and a first fiber reinforcing material is supplied at the second material inlet of the compounding extruder, which discharges a molten random fiber reinforced thermoplastic material at the extruder outlet. The fiber reinforcing material may include a bundle of continuous fibers formed from a plurality of monofilament fibers. Fiber types disclosed include glass, carbon, graphite and Kevlar.

U.S. Pat. No. 5,595,696 to Schlarb et al. discloses a fiber composite plastic and a process for the preparation thereof and more particularly to a composite material comprising continuous fibers and a plastic matrix. The fiber types include glass, carbon and natural fibers, and can be fed to the extruder in the form of chopped or continuous fibers. The continuous fiber is fed to the extruder downstream of the resin feed hopper.

U.S. Pat. No. 6,395,342 to Kadowaki et al. discloses an impregnation process for preparing pellets of a synthetic organic fiber reinforced polyolefin. The process comprises the steps of heating a polyolefin at the temperature which is higher than the melting point thereof by 40° C. or more to lower than the melting point of a synthetic organic fiber to form a molten polyolefin; passing a reinforcing fiber comprising the synthetic organic fiber continuously through the molten polyolefin within six seconds to form a polyolefin impregnated fiber; and cutting the polyolefin impregnated fiber into the pellets. Organic fiber types include polyethylene terephthalate, polybutylene terephthalate, polyamide 6, and polyamide 66.

U.S. Pat. No. 6,419,864 to Scheuring et al. discloses a method of preparing filled, modified and fiber reinforced thermoplastics by mixing polymers, additives, fillers and fibers in a twin screw extruder. Continuous fiber rovings are fed to the twin screw extruder at a fiber feed zone located downstream of the feed hopper for the polymer resin. Fiber types disclosed include glass and carbon.

Application Ser. No. 11/318,363, filed Dec. 13, 2005, notes that consistently feeding PET fibers into a compounding extruder is a problem encountered during the production of polypropylene (PP)-PET fiber composites. Conventional gravimetric or vibrational feeders used in the metering and conveying of polymers, fillers and additives into the extrusion compounding process, while effective in conveying pellets or powder, are not effective in conveying cut fiber. Another issue encountered during the production of PP-PET fiber composites is adequately dispersing the PET fibers into the PP matrix while still maintaining the advantageous mechanical properties imparted by the incorporation of the PET fibers. More particularly, extrusion compounding screw configuration may impact the dispersion of PET fibers within the PP matrix, and extrusion compounding processing conditions may impact not only the mechanical properties of the matrix polymer, but also the mechanical properties of the PET fibers. Application Ser. No. 11/318,363, filed Dec. 13, 2005, proposes solutions to these problems.

Despite advances in the art, a need exists for a composite headliner substrate panel having improved stiffness, surface finish, impact resistance and flexural modulus characteristics and for a process for making such fiber reinforced polypropylene composite headliner substrate panels. Furthermore, it would be an advancement in the art to provide a fiber reinforced polypropylene composite headliner substrate panel for use in an overhead airbag assembly that permits deployment of the airbag without permitting roof elements to strike the vehicle occupants.

### SUMMARY OF THE INVENTION

Provided is a fiber reinforced polypropylene composite headliner substrate panel. The fiber reinforced polypropylene composite headliner substrate panel is molded from a composition comprising at least 30 wt % polypropylene based resin, from 10 to 60 wt % organic fiber and from 0 to 40 wt % inorganic filler, based on the total weight of the composition, the composite headliner substrate panel having an outer surface and an underside surface.

In another aspect, provided is a process for producing a fiber reinforced polypropylene composite headliner substrate panel for a vehicle. The process includes the step of molding a composition to form the headliner substrate panel for a vehicle, the headliner substrate panel having at least an outer surface and an underside surface, wherein the composition comprises at least 30 wt % polypropylene, from 10 to 60 wt % organic fiber and from 0 to 40 wt % inorganic filler, based on the total weight of the composition.

In yet another aspect, provided is a process for making fiber reinforced polypropylene composite headliner substrate panels, comprising the steps of: feeding into a twin screw extruder hopper at least about 25 wt % of a polypropylene based resin with a melt flow rate of from about 20 to about 1500 g/10 minutes; continuously feeding by unwinding from one or more spools into the twin screw extruder hopper from about 5 wt % to about 40 wt % of an organic fiber; feeding into a twin screw extruder from about 10 wt % to about 60 wt % of an inorganic filler; extruding the polypropylene based resin, the organic fiber, and the inorganic filler through the twin screw extruder to form a fiber reinforced polypropylene composite melt; cooling the fiber reinforced polypropylene composite melt to form a solid fiber reinforced polypropylene composite; and molding the fiber reinforced polypropylene composite to form the headliner substrate panel, the headliner substrate panel having an outer surface and an underside surface.

It has surprisingly been found that high quality composite headliner substrate panels can be produced from substantially lubricant-free fiber reinforced polypropylene compositions, the resultant headliner substrate panels possessing a flexural modulus of at least 300,000 psi and exhibiting ductility during instrumented impact testing. Particularly surprising is the ability to make such composite headliner substrate panels using a wide range of polypropylenes as the matrix material, including some polypropylenes that, without fiber, are very brittle.

It has also been surprisingly found that organic fiber may be fed into a twin screw compounding extruder by continuously unwinding from one or more spools into the feed hopper of the twin screw extruder, and then chopped into ¼ inch to 1 inch lengths by the twin screws to form a fiber reinforced polypropylene based composite for use in producing high quality composite headliner substrate panels.

Numerous advantages result from the composite headliner substrate panels and the method of making disclosed herein and the uses/applications therefore.

For example, in exemplary embodiments of the present disclosure, the disclosed polypropylene fiber composite headliner substrate panels exhibit improved instrumented impact resistance.

In a further exemplary embodiment of the present disclosure, the disclosed polypropylene fiber composite headliner substrate panels exhibit improved flexural modulus.

In a further exemplary embodiment of the present disclosure, the disclosed polypropylene fiber composite headliner substrate panels do not splinter during instrumented impact testing.

In yet a further exemplary embodiment of the present disclosure, the disclosed polypropylene fiber composite headliner substrate panels exhibit fiber pull out during instrumented impact testing without the need for lubricant additives.

In yet a further exemplary embodiment of the present disclosure, the disclosed polypropylene fiber composite headliner substrate panels exhibit a higher heat distortion temperature compared to rubber toughened polypropylene.

In yet a further exemplary embodiment of the present disclosure, the disclosed polypropylene fiber composite headliner substrate panels exhibit a lower flow and cross flow coefficient of linear thermal expansion compared to rubber toughened polypropylene.

In still yet a further exemplary embodiment of the present disclosure, the disclosed polypropylene fiber composite headliner substrate panels exhibit the ability to provide class A surface finishes.

These and other advantages, features and attributes of the disclosed polypropylene fiber composite headliner substrate panels, and method of making of the present disclosure and their advantageous applications and/or uses will be apparent from the detailed description which follows, particularly when read in conjunction with the figures appended hereto.

### BRIEF DESCRIPTION OF THE DRAWINGS

To assist those of ordinary skill in the relevant art in making and using the subject matter hereof, reference is made to the appended drawings, wherein:

FIG. 1 is a side elevation, sectional view of a vehicle incorporating a fiber reinforced polypropylene composite headliner substrate panel in connection with an overhead airbag assembly, with an airbag module shown in the stowed configuration;

FIG. 2 is a side elevation, sectional view of the vehicle of FIG. 1, with the overhead airbag module shown in the deployed configuration;

FIG. 3 is an exploded, perspective view of the fiber reinforced polypropylene composite headliner substrate panel used in the headliner assembly of the overhead airbag assembly of FIG. 1;

FIG. 4 is an enlarged side elevation, sectional view of the overhead airbag assembly of FIG. 1, with the airbag module shown in the stowed configuration;

FIG. 5 is an enlarged side elevation, sectional view of the overhead airbag assembly of FIG. 1, with the airbag module shown in the deployed configuration;

FIG. 6 is a perspective view illustrating within a vehicle an overhead curtain airbag system, in a deployed position, employing a fiber reinforced polypropylene composite headliner substrate panel of the present invention;

FIG. 7 is a side view showing, in a housed position, an overhead curtain airbag system housed behind a fiber reinforced polypropylene composite headliner substrate panel of the present invention;

FIG. 8 is a cross-sectional view taken along line 7-7 of FIG. 7;

FIG. 9 is a side view showing a deployed position of the overhead curtain airbag system;

FIG. 10 is a cross-sectional view taken along line 9-9 of FIG. 9 showing a fiber reinforced polypropylene composite headliner substrate panel of the present invention following deployment of an overhead curtain airbag system;

FIG. 11A is a schematic top plan view of a fiber reinforced polypropylene composite headliner substrate panel in connection with an overhead curtain airbag system;

FIG. 11B is a schematic frontal view of a fiber reinforced polypropylene composite headliner substrate panel employed in connection with an overhead curtain airbag system, depicted in a deployed position;

FIG. 12 depicts an exemplary schematic of the process for making fiber reinforced polypropylene composites used to form the headliner panels of the instant invention;

FIG. 13 depicts an exemplary schematic of a twin screw extruder with a downstream feed port for making fiber reinforced polypropylene composites used to form the headliner panels of the instant invention; and

FIG. 14 depicts an exemplary schematic of a twin screw extruder screw configuration for making fiber reinforced polypropylene composites used to form the headliner panels of the instant invention.

### DETAILED DESCRIPTION OF THE INVENTION

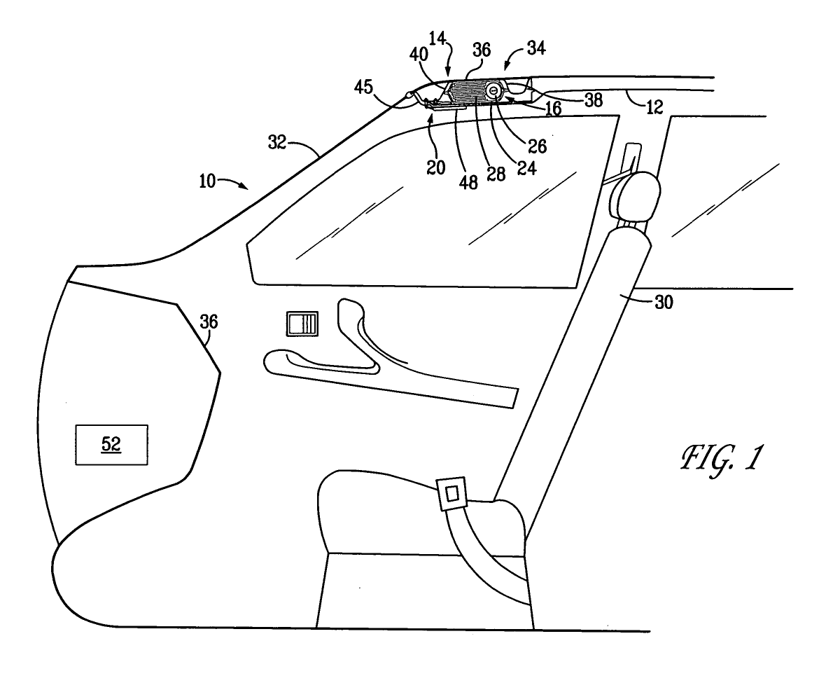

Reference is now made to FIGS. 1-14, wherein like numerals are used to designate like parts throughout.

Disclosed herein are improved fiber reinforced polypropylene composite headliner substrate panels and a process for their production. Composite headliner substrate panels of the type contemplated herein are generically depicted in FIGS. 1-5 for a vehicle 10.

Referring to FIG. 1, a side elevation, sectional view depicts one embodiment of a vehicle 10 having a fiber reinforced polypropylene composite headliner substrate panel 12 according to the present invention. An overhead airbag assembly 14 may be employed in vehicle 10 to protect an occupant against the force of a frontal impact. The overhead airbag assembly 14 may include an overhead airbag module 16. As may be appreciated, a corresponding airbag module may be provided for the driver's side.

In one exemplary configuration of a vehicle 10, employing a fiber reinforced polypropylene composite headliner substrate panel 12 in conjunction with an overhead airbag assembly 14, the airbag module 16 may include a housing 24, an inflator 26, and an inflatable airbag 28. Housing 24 may be flexible or rigid, and may be formed from a variety of materials such as fabrics, plastics, metals, and the like. The inflator may be of any known type, including pyrotechnic, compressed gas, or hybrid. The airbag 28 may be of a type that provides good frontal impact protection, with effectiveness for out-of-position occupants. Due to inherent space limitations, the airbag module 16 should be relatively thin so that the thickness of the roof 34 need not be increased substantially to accommodate airbag module 16.

As shown, the inflator 26 may be disposed within the housing 24, along with the airbag 28. However, as may be appreciated by those skilled in the art, the inflator 26 may be separate from the housing 24 and may deliver inflation gas to the airbag 28 using a tube-like gas guide. Thus, the inflator 26 may be positioned at any desirable location within the vehicle to avoid the space constraints of roof 34.

As is conventional, vehicle 10 includes, among other things, a seat 30, a windshield 32, a roof 34 and an instrument panel 36. The roof 34 includes a generally flat portion 36, and may include support ribs 38, and a header 40. The header 40 supports and connects the windshield 32 to the roof 34. The airbag module 16 may be affixed at one or more points to the generally flat portion 36, the support ribs 38, and/or the header 40. As depicted, the airbag module 16 is disposed between a support rib 38 and the header 40. As shown, the airbag module 16 may be configured to compactly fit in the overhead position without requiring any significant addition to the thickness of the roof 34.

As shown in FIG. 1, a headliner assembly 20 conceals the overhead airbag assembly 14, as well as airbag module 16, ribs 38, and header 40. Headliner assembly 20 advantageously includes a fiber reinforced polypropylene composite headliner substrate panel 12, which will be described in more detail below, as well as one or more pieces of header trim 46. As may be appreciated, FIG. 1 depicts only the passenger side of vehicle 10. As shown, the header trim 46 may be disposed to conceal the header 40 from the occupants. The fiber reinforced polypropylene composite headliner substrate panel 12 extends rearward from the header trim 46 to conceal the airbag module 16 and other elements of roof 34 from the occupants.

Optionally, the headliner assembly 20 may also include sun visors 48 for the driver and passenger sides of vehicle 10. As is conventional, the sun visors 48 are configured to be oriented by vehicle occupants to block direct sunlight. Sun visors 48 may be attached to header 40 through header trim 46, as depicted. Alternatively, the sun visor 48 may be attached directly to the header trim 46.

In the embodiment of FIG. 1, the overhead airbag assembly 14 also has an electronic control unit (ECU) 52, which may be positioned anywhere within vehicle 10. As shown, ECU 52 is installed within instrument panel 36, between the passenger and engine compartments. During normal operation of the vehicle 10, one or more airbag modules 16 may be connected to the ECU 52. The ECU 52 is connected to a sensor, which continuously monitors the acceleration and deceleration of vehicle 10.

The acceleration and deceleration information is sent to a processor, which employs an algorithm to determine whether a collision has occurred. The ECU 52 may also utilize occupant-related data to determine the response necessary during an accident situation. If an accident has occurred, ECU 52 transmits an electrical current to an initiator of the inflator 26 to initiate deployment of the airbag module 16.

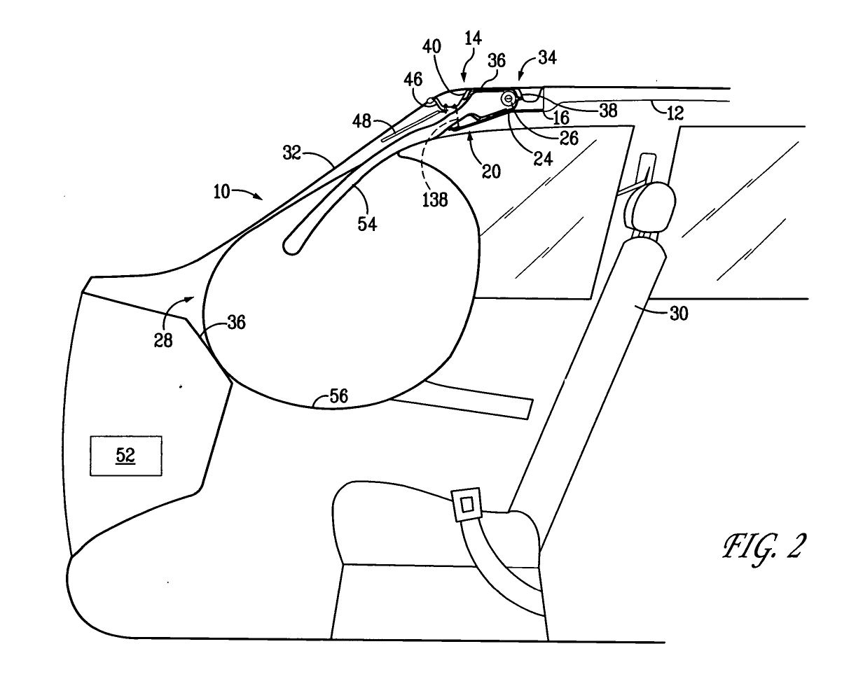

Referring to FIG. 2, a side elevation, sectional view illustrates the overhead airbag assembly 14 in the deployed configuration. Upon activation, the inflator 26 expels inflation gas into the airbag 28. The airbag 28 initially inflates in a direction generally parallel to the windshield 32. Airbag 28 has an inflation tube 54, into which the inflation gas first flows from the inflator 26. The inflation tube 54 inflates to propel a main airbag body 56 out of the housing 24, along the windshield 32 and the main airbag body 56 further expands to provide forward impact protection.

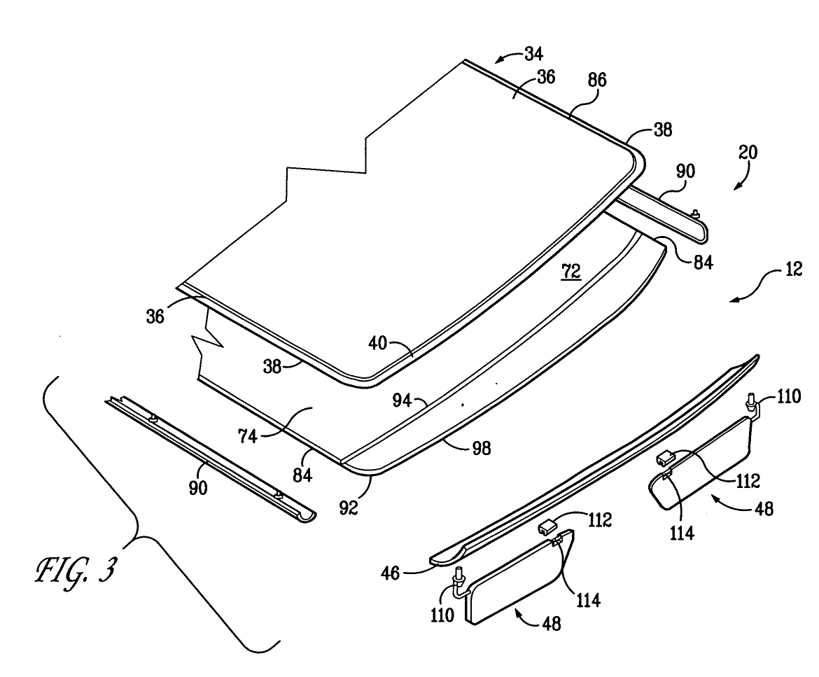

Referring to FIG. 3, an exploded, perspective view depicts a portion of the headliner assembly 20 along with a corresponding portion of the roof 34. As described previously, the headliner assembly 20 includes the fiber reinforced polypropylene composite headliner substrate panel 12 of the present invention, headliner trim 46 and sun visors 48.

The fiber reinforced polypropylene composite headliner substrate panel 12 has a driver side portion 72 and a passenger side portion 74. The fiber reinforced polypropylene composite headliner substrate panel 12 extends forward far enough to generally overlap the header 40. The fiber reinforced polypropylene composite headliner substrate panel 12 has peripheral edges 84 that may be attached to corresponding peripheral edges 86 of the roof 34. According to another example, the roof 34 may also have a pair of roof rails 88 positioned at the peripheral edges 86 of the roof 34. The roof rails 88 may be connected to the header 40 so that the roof rails 88 and the header 40 form one continuous structure. The peripheral edges 84 of the fiber reinforced polypropylene composite headliner substrate panel 12 may be clamped against the roof rails 88 by pieces of roof rail trim 90, which extend to cover the roof rails 88. The pieces of roof rail trim 90 may optionally be part of the headliner assembly 20.

In vehicles employing overhead airbag systems, the fiber reinforced polypropylene composite headliner substrate panel 12 may be provided with an airbag door 92 that permits the airbag 28 to emerge from the compartment formed between the roof 34 and the fiber reinforced polypropylene composite headliner substrate panel 12. If desired, the fiber reinforced polypropylene composite headliner substrate panel 12 may be provided with a channel 94 that extends as shown in FIG. 3. Channel 94 may be formed in the upper portion of the fiber reinforced polypropylene composite headliner substrate panel 12, so as not to be visible to the occupant 12. The fiber reinforced polypropylene composite headliner substrate panel 12 also has a forward edge 98.

Channel 94, forward edge 98 and the portion of the peripheral edges 84 that lie forward of the channel 94 cooperate to form the airbag door 92. Forward edge 98 is releasably attached to the roof 34 by header trim 46. The aforementioned portion of the peripheral edge 84 may also be releasably retained against the roof 34 by the roof rail trim 90. As such, the edges of the airbag door 92 are not visible during normal vehicle operation because they are covered by the header trim 46 and the roof rail trim 90.

As the airbag 28 begins to inflate, it presses against the airbag door 92. This pressure serves to release the forward edge 98 and the aforementioned portion of the peripheral edge 84 from the roof 34. The airbag door 92 is then able to pivot downward along the channel 94 to provide space for the emergence of the airbag 28 between the fiber reinforced polypropylene composite headliner substrate panel 12 and the header 40.

The sun visors 48 may be attached to the header 40 through the header trim 46. As such, header trim 46 may be provided with visor pivot holes and visor retention holes. It must be noted that the mounting of the sun visors 48 cannot impede detachment of the forward edge 98 from roof 34 during deployment of airbag module 16. Header trim 46, and the pieces of roof rail trim 90 may be attached to the roof 34 via fasteners (not shown), such as by nuts and bolts. Adhesives, welding, and other attachment techniques may also be used.

If desired, the headliner assembly 20 may be assembled prior to attachment of the header trim 46, or roof rail trim 90 to the roof 34. For example, the fiber reinforced polypropylene composite headliner substrate panel 12 may be attached to the header trim 46, and roof rail trim 90 via an adhesive. The portion of the fiber reinforced polypropylene composite headliner substrate panel 12 that is designed to be removable from the roof 34 may be either weakly attached or devoid of any attachment to the header trim 46, and/or roof rail trim 90. Once assembled, the headliner assembly 20 may be installed in the vehicle 10 by fasteners or the like.

As is conventional, the sun visors 48 may each have a pivotal attachment 110, such as a pivoting bolt or the like, and a retainer 112. Each retainer 112 may be releasably affixed to element 114 of sun visor 48 so that the occupant can pull the sun visor 48 free of the retainer 112 to move the sun visor 48 to cover part of a side window. The pivotal attachments 110 and the retainers 112 may each be attached to the header 40 through the visor pivot hole and visor retention hole, respectively, of header trim 46.

According to one alternative embodiment, the sun visors 48 may be attached to the header trim 46 prior to installation of the headliner assembly 20 in vehicle 10. Thus, the sun visors 48 may be part of the headliner assembly 20. Upon attachment of the headliner assembly 20 to the roof 34, the sun visors 48 may then be attached to the header 40 as well header trim 46, or they may simply remain attached to header trim 46.

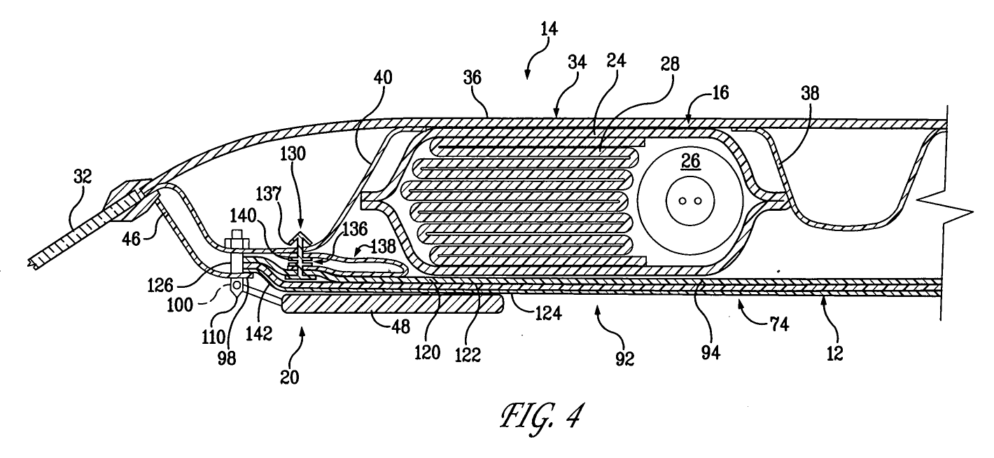

Referring now to FIG. 4, a side elevation, sectional view depicts an enlarged view of the overhead airbag assembly 14 and a front portion of roof 34 of the vehicle 10. This sectional view is taken through the same plane as that of FIGS. 1 and 2. Fiber reinforced polypropylene composite headliner substrate panel 12 may be formed so as to have a plurality of layers. As shown, one embodiment of fiber reinforced polypropylene composite headliner substrate panel 12 may include a top layer 120, a substrate layer 122, and a bottom covering layer 124. According to one embodiment, the bottom cover 124 is constructed of a fabric designed to match other interior surfaces of vehicle 10, which may include, by way of example and not of limitation, header trim 46 and roof rail trim 90. According to alternative embodiments, the fiber reinforced polypropylene composite headliner substrate panel 12 may be structured and layered in a wide variety of ways. The layers of fiber reinforced polypropylene composite headliner substrate panel 12 may be co-extruded, and then thermoformed to a desired shape, or may be formed separately and attached together by conventional means.

The pivotal attachment 110 of sun visor 48 may be attached to the header 40 via a fastener 126, as depicted. The fastener 126 may take the form of a bolt/nut combination, a rivet, a screw, or any of a variety of other fastener types. As mentioned previously, the pivotal attachment 110 may alternatively be attached only to the header trim 46.

As described previously, the forward edge 98 of fiber reinforced polypropylene composite headliner substrate panel 12 is installed between the header 40 and the header trim 46. As such, the forward edge 98 is attached to the header 40. The header trim 46 may optionally exert force against the forward edge 98 to grip the forward edge 98 against the header 40. Furthermore, the forward edge 98 may be attached to the header 40 via frangible fastener 130. The overhead airbag assembly 14 may also include a tether 138 with a first end 140 and a second end 142, each end affixed by way of a frangible fastener 130. The tether 138 may be formed of a fabric such as seat belt webbing, a wire, or some other somewhat flexible material.

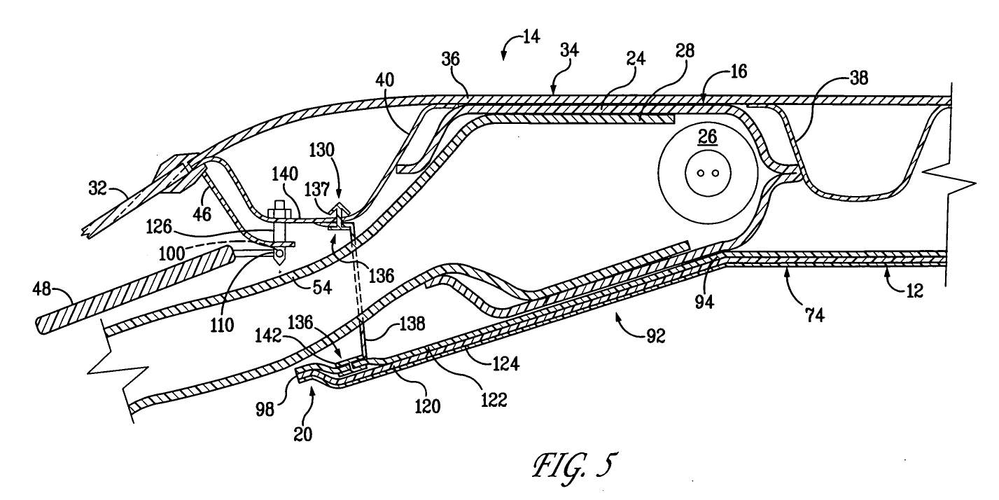

A frangible section 136 of frangible fastener 130 is designed to permit separation when a threshold level of tension is reached in the frangible portion 136. When the airbag 28 begins to inflate, the airbag 28 exerts pressure on the housing 24 of the airbag module 16. The housing 24, in turn, presses downward against the airbag door 92, thereby transmitting tensile force to the frangible portion 136. The frangible portion 136 then breaks to permit the airbag door 92 to open to release the airbag 28 into the passenger compartment of the vehicle 10. The airbag 28 continues to inflate to obtain the configuration depicted in FIG. 5.

Referring to FIG. 5, a side elevation, sectional view depicts an enlarged view of the overhead airbag assembly 14 and the front portion of the roof 34 of vehicle 10. Once again, the sectional view is taken through the same plane as FIGS. 1, 2 and 4. The airbag module 16 is deployed to provide frontal impact protection for an occupant.

As previously described with respect to FIG. 4, the frangible portion 136 is shown in a fractured state to permit separation. The forward edge 98 of fiber reinforced polypropylene composite headliner substrate panel 12 has pulled free of the header trim 46. Additionally, the portion of the peripheral edge 84 (not visible) of airbag door 92 has also pulled free of the roof rail trim 90 (not visible).

The airbag door 92 has opened by pivoting about the channel 94 to provide an opening through which the airbag 18 can inflate. Housing 24 has also opened. The airbag 18 has emerged through the housing 24 and the airbag door 92 and inflated to obtain the configuration depicted in FIG. 2. The sun visor 48 has been pivoted forward by the airbag 28, thereby removing the sun visor 48 from the path of the airbag 28. Forward attachment of the sun visor 48 helps the sun visor 48 to pivot in the manner shown, regardless of whether the sun visor is seated against fiber reinforced polypropylene composite headliner substrate panel 12 at the time of deployment. Inflation tube 54 may extend through the airbag door 92, as depicted.

Tether 138 has been drawn taught by motion of the forward edge 98 away from the header 40. The range of pivotal motion of the airbag door 92 is thereby limited by the length of the tether 138 so that the airbag door 92 is unable to open far enough to impede inflation of the airbag 28 or strike an occupant.

As may be appreciated by those skilled in the art, overhead airbag systems may be configured in any number of alternative designs and benefit from the fiber reinforced polypropylene composite headliner substrate panels contemplated herein. One such alternative configuration employs a component of the airbag module 16 that directly breaks through the fiber reinforced polypropylene composite headliner substrate panel 12. This can be acceptable so long as no splintering occurs. Advantageously, the fiber reinforced polypropylene composites disclosed herein do not splinter and, as such, are vastly superior to other materials when used in such designs. Instead of shattering, under impact loading, a fiber reinforced polypropylene composite headliner substrate panel made from the compositions disclosed herein exhibit a “hinge-effect” rather than breaking, minimizing injury to the occupants. By “hinge-effect” is meant that the fibers of the composition are effective to connect otherwise fractured pieces after impact. An additional benefit of the fiber reinforced polypropylene composites disclosed herein is that class A surfaces may be obtained, free of aesthetic blemishes and defects. Further, the heat distortion temperature of these materials range from 130-140° C., much higher than the 80-100° C. heat distortion temperature of rubber modified polypropylenes.

As may be appreciated, the forming of other headliner panel designs from the fiber reinforced polypropylene composites disclosed herein is contemplated and within the scope of the present invention. Such headliner panels may be associated with airbags or not and still benefit from the advantageous properties of the fiber reinforced polypropylene composites disclosed herein.

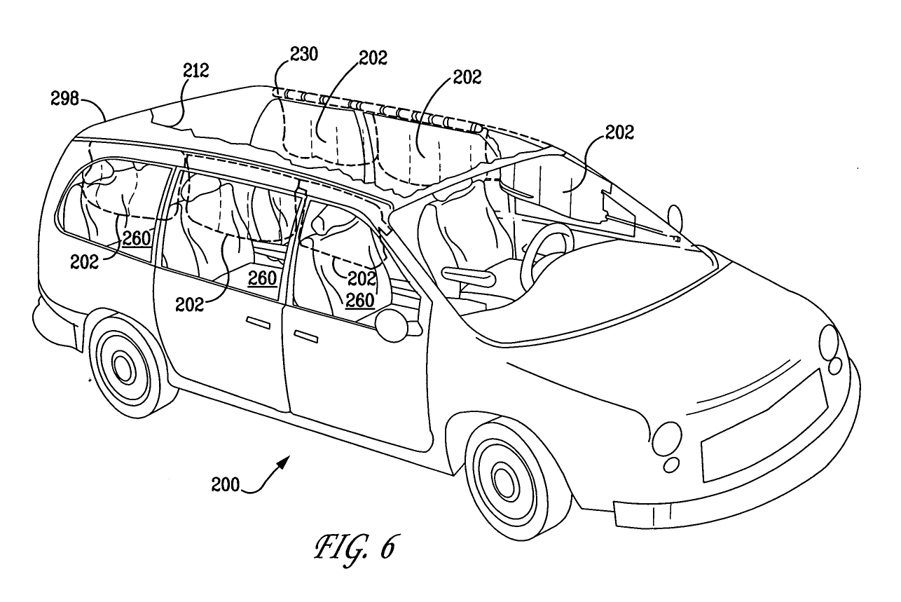

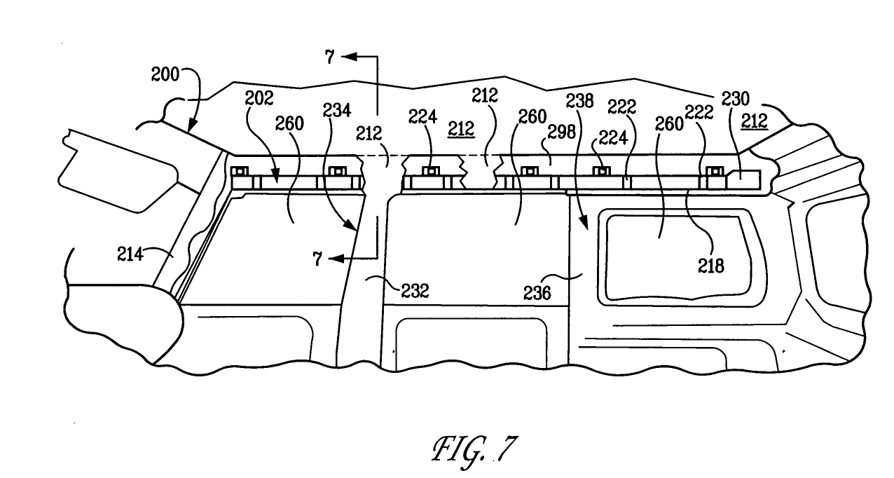

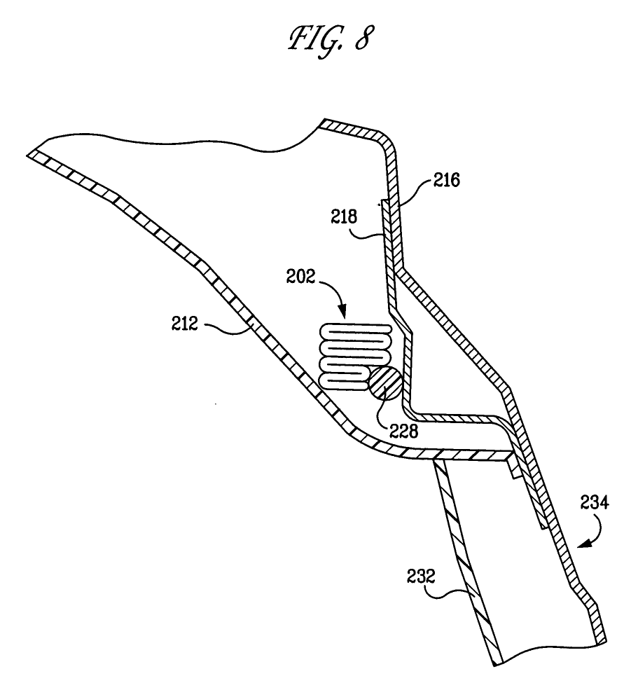

Referring to FIGS. 6-11B, an overhead curtain airbag system is described that employs a fiber reinforced polypropylene composite headliner substrate panel 212, in accordance with another form of the present invention. Referring to FIG. 6, a vehicle 200 having an overhead curtain airbag system is shown in a perspective, partial cutaway, with the overhead curtain airbag system in a deployed position. In FIG. 7, a side view taken from the interior of vehicle 200 shows an overhead curtain airbag system in a housed position to better view the exemplary fiber reinforced polypropylene composite headliner substrate panel 212 contemplated herein. FIG. 8 presents a cross-sectional view taken along line 7-7 of FIG. 7.

As illustrated in FIG. 7, vehicle 200 is shown, for purposes of example but not by way of limitation, to be of a type having relatively wide side windows 260 and a tall body, such as a passenger van, mini-van or sport utility vehicle. A curtain airbag 202 extends along from a front pillar portion (A pillar portion) 214 to a roof side rail portion 216 of the vehicle 200, and is stored in a position folded in between a roof side rail member (vehicle body component) 218 and a fiber reinforced polypropylene composite headliner substrate panel 212. The roof side rail member 218 is attached to the roof side rail portion 216, as shown in FIG. 8, and the fiber reinforced polypropylene composite headliner substrate panel 212 is attached so as to cover a surface of the roof side rail member 218. The airbag 202 is retained in its folded position by, for example, being wound with tape 222 at several places. The airbag 202 is secured to the roof side rail member 218 through projections 224 disposed in an upper end portion of the airbag 202 at several places.

In a lower end portion of airbag 202, an airbag displacement member 228 may be is disposed in the inside of airbag 202. The displacement member 228 is retained in a position on the side of the roof side rail member 218 under the airbag 202. Disposed in a rear end portion of the roof side rail portion 216 is an inflator 230 connected to a rear end portion of the airbag 202.

The fiber reinforced polypropylene composite headliner substrate panel 212 may be configured so as to provide an end that is detachably fastened to the roof side rail member 218 by using a center pillar cover trim 232 of a center pillar portion (B pillar portion) 234 and a quarter pillar cover trim 236 of a quarter pillar portion (C pillar portion) 238 as shown in FIG. 7. The ends of the fiber reinforced polypropylene composite headliner substrate panel 212 are also detachably fastened by using, for example, a door opening trim, not shown.

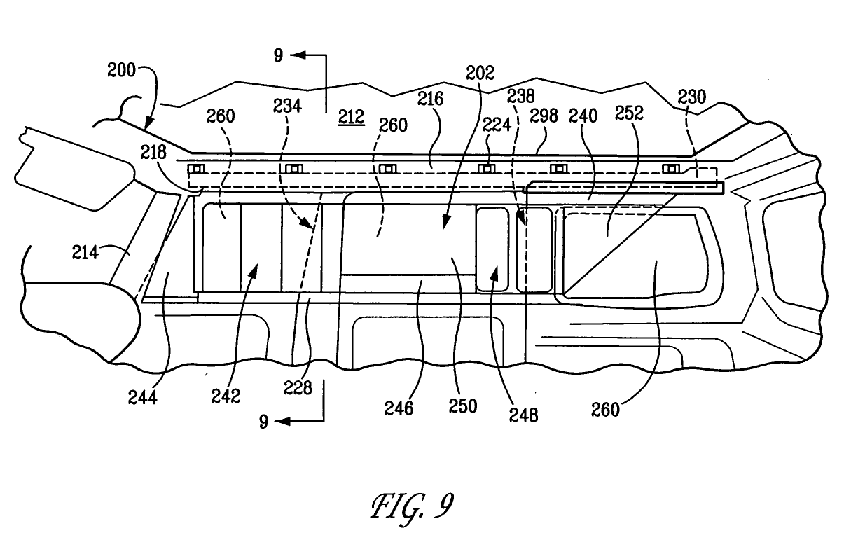

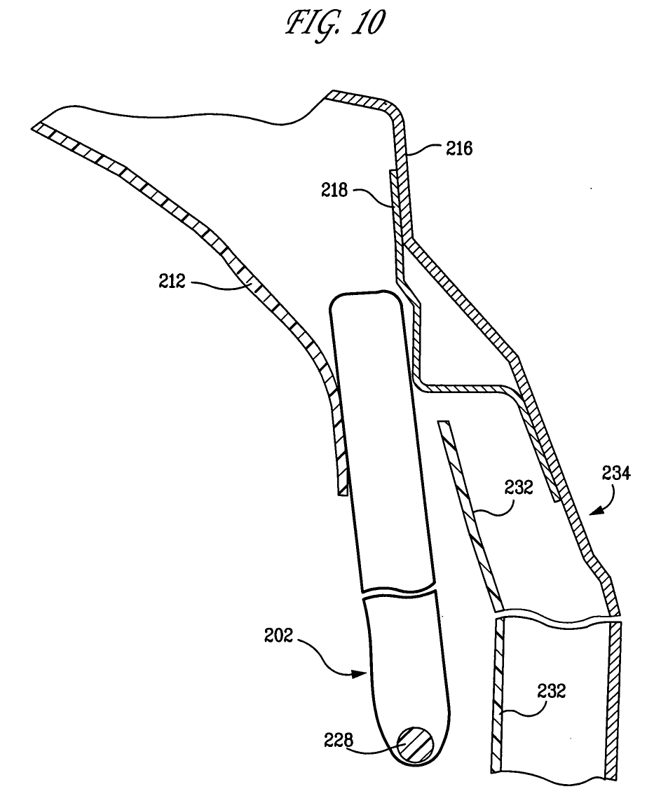

FIG. 9 is a side view showing a deployed overhead curtain airbag system of the type described above, and FIG. 10 is a cross-sectional view taken along line 9-9 of FIG. 9. As illustrated in FIG. 9, the airbag 202 is made up of an inflatable portion 240 provided along the roof side rail portion 216 located in the upper end portion, an inflatable portion 242 and a fabric portion 244 both positioned on a front seat side, and inflatable portions 246 and 248 and fabric portions 250 and 252 all positioned on a back seat side.

The inflatable portions 240 and 246 extend in a longitudinal direction of the vehicle 200, and the inflatable portions 242 and 248 extend in a vertical direction of the vehicle 200, although, as may be appreciated, several configurations are contemplated. The inflatable portion 240 internally communicates with each of the inflatable portions 242 and 248, while the inflatable portion 246 internally communicates with the inflatable portions 242 and 248 that are disposed with the inflatable portion 246 therebetween.

A front end of a lower end portion of the triangular fabric portion 244 is secured to the A pillar portion 214, while a side of a rear end thereof is joined to a side of a front end of the inflatable portion 242. Each side of the four-sided fabric portions 250 is joined to the inflatable portions 240, 242, 246 and 248 respectively. A side of an upper end of the triangular fabric portion 252 is joined to the inflatable portion 240, and a side of a front end to the inflatable portion 248.

Displacement member 228 may also be formed from a fiber reinforced polypropylene composite and is designed to have a requisite amount of weight, rigidity and elasticity. Displacement member 228 may have a circular section, as shown or any other suitable cross-section.

In operation, if a predetermined or greater side impact is applied to a side body of the vehicle 200 in a side collision or the like, an airbag activation sensor, not shown, sends a signal to a control unit, also not shown. In response to the signal, the control unit sends an activation signal to the inflator 230, and the inflator 230 then injects gas into the airbag 202. The gas from the inflator 230 flows into the inflatable portion 240 of the airbag 202, which expands the inflatable portion 240. The expansion of the inflatable portion 240 breaks the tapes 222 and the gas sequentially flows into the inflatable portions 248, 242 and 246 to expand the inflatable portions 248, 242 and 246. At the same time, the fabric portions 244, 250 and 252 are also deployed.

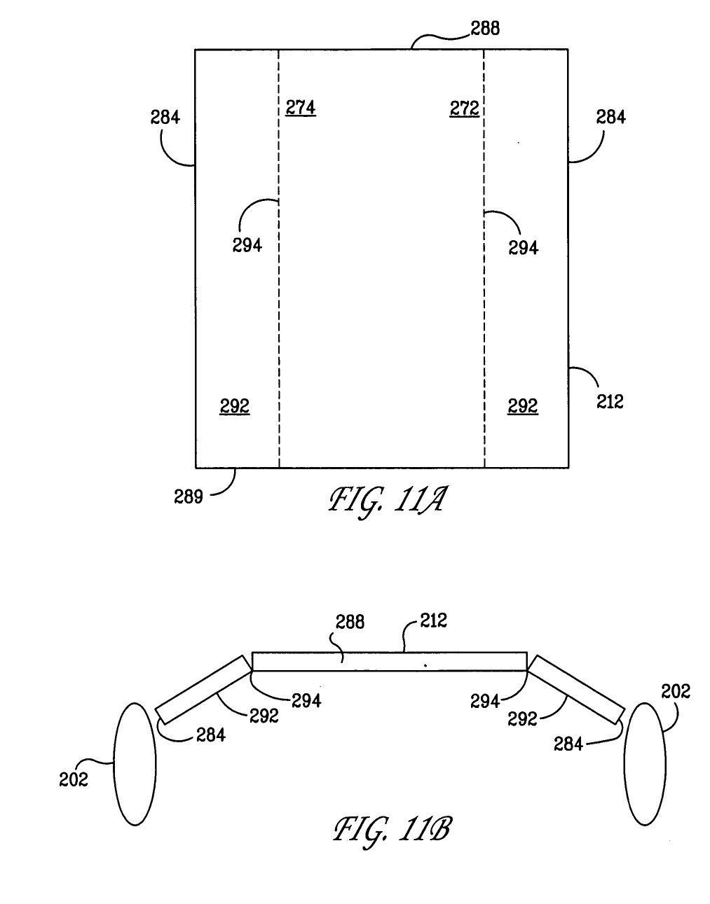

In this process, the airbag 202 presses against the fiber reinforced polypropylene composite headliner substrate panel 212 by using the displacement member 228 contained in the lower end portion thereof, and releases the peripheral edges 284 of the fiber reinforced polypropylene composite headliner substrate panel 212 (see FIG. 11A) from the center pillar cover trim 232 and quarter pillar cover trim 236 and the door opening trim to detach the end of the fiber reinforced polypropylene composite headliner substrate panel 220 from the roof side rail member 218, as shown in FIG. 10. The airbag 202 is then deployed while pushing and bending the fiber reinforced polypropylene composite headliner substrate panel 212 toward the inside of the vehicle as shown in FIG. 9 and FIG. 11B. As such, the end of the fiber reinforced polypropylene composite headliner substrate panel 2112 can be easily detached from the roof side rail member 218 by means of the displacement member 228, which enables prompt and reliable deployment of the airbag 202.

Referring to FIG. 11A, a schematic overhead plan view depicts a fiber reinforced polypropylene composite headliner substrate panel 212, according to a form of the present invention. The fiber reinforced polypropylene composite headliner substrate panel 212 has a driver side portion 272 and a passenger side portion 274. The fiber reinforced polypropylene composite headliner substrate panel 212 has peripheral edges 284 that may be attached to from the roof side rail members 218 of the roof 298 (see also FIGS. 7 and 9). The peripheral edges 284 of the fiber reinforced polypropylene composite headliner substrate panel 212 may be clamped against the roof side rail members 218 of the roof 298 by pieces of center pillar cover trim 232 and other pieces of cover trim, as described below.

Referring also to FIG. 11B, the fiber reinforced polypropylene composite headliner substrate panel 212 may be provided with airbag doors 292 that permit the curtain airbags 202 to emerge from the compartment formed between the roof 298 and the fiber reinforced polypropylene composite headliner substrate panel 212. If desired, the fiber reinforced polypropylene composite headliner substrate panel 212 may be provided with channels 294 that extend as shown in FIG. 11A. Channels 294 may be formed in the upper portion of the fiber reinforced polypropylene composite headliner substrate panel 212, so as not to be visible to the occupant. The fiber reinforced polypropylene composite headliner substrate panel 212 also has a forward edge 288 and a rearward edge 289.

As shown in FIGS. 11A and 11B, channels 294, the portions of the forward edge 288 and rearward edge 289 that lie to the outside of channels 294, and peripheral edges 284, cooperate to form airbag doors 292. As indicated, peripheral edges 284 are releasably attached to the roof 298 by A-pillar cover trim, center pillar cover trim 232, quarter pillar cover trim 236 and door opening trim. As such, the edges of the airbag doors 292 are not visible during normal vehicle operation because they are covered by the trim pieces.

Still referring to FIGS. 11A and 11B, as the airbags 202 begin to inflate, they press against the airbag doors 292. This pressure serves to release the aforementioned portions of the forward edge 288 and rearward edges 289 and peripheral edges 284 from the roof 298. The airbag doors 292 are then able to pivot downward along the channels 294 to provide space for the emergence of the airbags 202 between the fiber reinforced polypropylene composite headliner substrate panel 212 and the roof 298.

Although, as shown, the peripheral edges 284 of the fiber reinforced polypropylene composite headliner substrate panel 212 are detached from the roof side rail members 218 by using displacement members 228, systems may be configured in any number of alternative designs and still benefit from the fiber reinforced polypropylene composite headliner substrate panels contemplated herein.

As may be appreciated by those skilled in the art, vehicles may be designed to combine the features of the overhead frontal airbag system depicted in FIGS. 1-5, with the overhead curtain airbag system of FIGS. 6-11B, to benefit from the combined features of the two airbag systems and the fiber reinforced polypropylene composite headliner substrate panels disclosed herein.

Additionally, the fiber reinforced polypropylene composite headliner substrate panels contemplated herein may be subjected to further processing, such as by two-shot/2K injection molding. For example, a sealing member of thermoplastic vulcanizate (TPV) can be molded onto a composite headliner substrate panel using two-shot/2K injection molding. Also, as mentioned above, in some automobile applications, it may be desirable to cover the fiber reinforced polypropylene composite headliner substrate panels in cloth, for appearance or aesthetic purposes, despite the fact the part can be produced with an otherwise acceptable surface finish.

The fiber reinforced polypropylene composite headliner substrate panels contemplated herein are molded from a composition comprising a combination of a polypropylene based matrix with organic fiber and inorganic filler, which in combination advantageously yield headliner substrate panels with a flexural modulus of at least 300,000 psi and ductility during instrumented impact testing (15 mph, −29° C., 25 lbs). The fiber reinforced polypropylene headliner substrate panels employ a polypropylene based matrix polymer with an advantageous high melt flow rate without sacrificing impact resistance. In addition, the fiber reinforced polypropylene composite headliner substrate panels disclosed herein do not splinter during instrumented impact testing.

The fiber reinforced polypropylene composite headliner substrate panels have a flexural modulus of at least 350,000 psi, or at least 370,000 psi, or at least 390,000 psi, or at least 400,000 psi, or at least 450,000 psi. Still more particularly, the fiber reinforced polypropylene composite headliner substrate panels have a flexural modulus of at least 600,000 psi, or at least 800,000 psi. It is also believed that having a weak interface between the polypropylene matrix and the fiber of the fiber reinforced polypropylene composite headliner substrate panels contributes to fiber pullout; and, therefore, may enhance toughness. Thus, there is no need to add modified polypropylenes to enhance bonding between the fiber and the polypropylene matrix, although the use of modified polypropylene may be advantageous to enhance the bonding between a filler, such as talc or wollastonite and the matrix. In addition, in one embodiment, there is no need to add lubricant to weaken the interface between the polypropylene and the fiber to further enhance fiber pullout. Some embodiments also display no splintering during instrumented dart impact testing, which yield a further advantage of not subjecting a person in close proximity to the impact to potentially harmful splintered fragments.

The fiber reinforced polypropylene composite headliner substrate panels disclosed herein are formed from a composition that includes at least 30 wt %, based on the total weight of the composition, of polypropylene as the matrix resin. In a particular embodiment, the polypropylene is present in an amount of at least 30 wt %, or at least 35 wt %, or at least 40 wt %, or at least 45 wt %, or at least 50 wt %, or in an amount within the range having a lower limit of 30 wt %, or 35 wt %, or 40 wt %, or 45 wt %, or 50 wt %, and an upper limit of 75 wt %, or 80 wt %, based on the total weight of the composition. In another embodiment, the polypropylene is present in an amount of at least 25 wt %.

The polypropylene used as the matrix resin for use in the fiber reinforced polypropylene composite headliner substrate panels contemplated herein is not particularly restricted and is generally selected from the group consisting of propylene homopolymers, propylene-ethylene random copolymers, propylene-α-olefin random copolymers, propylene block copolymers, propylene impact copolymers, and combinations thereof. In a particular embodiment, the polypropylene is a propylene homopolymer. In another particular embodiment, the polypropylene is a propylene impact copolymer comprising from 78 to 95 wt % homopolypropylene and from 5 to 22 wt % ethylene-propylene rubber, based on the total weight of the impact copolymer. In a particular aspect of this embodiment, the propylene impact copolymer comprises from 90 to 95 wt % homopolypropylene and from 5 to 10 wt % ethylene-propylene rubber, based on the total weight of the impact copolymer.

The polypropylene of the matrix resin may have a melt flow rate of from about 20 to about 1500 g/10 min. In a particular embodiment, the melt flow rate of the polypropylene matrix resin is greater 100 g/10 min, and still more particularly greater than or equal to 400 g/10 min. In yet another embodiment, the melt flow rate of the polypropylene matrix resin is about 1500 g/10 min. The higher melt flow rate permits for improvements in processability, throughput rates, and higher loading levels of organic fiber and inorganic filler without negatively impacting flexural modulus and impact resistance.

In a particular embodiment, the matrix polypropylene contains less than 0.1 wt % of a modifier, based on the total weight of the polypropylene. Typical modifiers include, for example, unsaturated carboxylic acids, such as acrylic acid, methacrylic acid, maleic acid, itaconic acid, fumaric acid or esters thereof, maleic anhydride, itaconic anhydride, and derivates thereof. In another particular embodiment, the matrix polypropylene does not contain a modifier. In still yet another particular embodiment, the polypropylene based polymer further includes from about 0.1 wt % to less than about 10 wt % of a polypropylene based polymer modified with a grafting agent. The grafting agent includes, but is not limited to, acrylic acid, methacrylic acid, maleic acid, itaconic acid, fumaric acid or esters thereof, maleic anhydride, itaconic anhydride, and combinations thereof.

The polypropylene may further contain additives commonly known in the art, such as dispersant, lubricant, flame-retardant, antioxidant, antistatic agent, light stabilizer, ultraviolet light absorber, carbon black, nucleating agent, plasticizer, and coloring agent such as dye or pigment. The amount of additive, if present, in the polypropylene matrix is generally from 0.1 wt %, or 0.5 wt %, or 2.5 wt %, to 7.5 wt %, or 10 wt %, based on the total weight of the matrix. Diffusion of additive(s) during processing may cause a portion of the additive(s) to be present in the fiber.

The invention is not limited by any particular polymerization method for producing the matrix polypropylene, and the polymerization processes described herein are not limited by any particular type of reaction vessel. For example, the matrix polypropylene can be produced using any of the well known processes of solution polymerization, slurry polymerization, bulk polymerization, gas phase polymerization, and combinations thereof. Furthermore, the invention is not limited to any particular catalyst for making the polypropylene, and may, for example, include Ziegler-Natta or metallocene catalysts.

The fiber reinforced polypropylene composite headliner substrate panels contemplated herein are formed from compositions that also generally include at least 10 wt %, based on the total weight of the composition, of an organic fiber. In a particular embodiment, the fiber is present in an amount of at least 10 wt %, or at least 15 wt %, or at least 20 wt %, or in an amount within the range having a lower limit of 10 wt %, or 15 wt %, or 20 wt %, and an upper limit of 50 wt %, or 55 wt %, or 60 wt %, or 70 wt %, based on the total weight of the composition. In another embodiment, the organic fiber is present in an amount of at least 5 wt % and up to 40 wt %.

The polymer used as the fiber is not particularly restricted and is generally selected from the group consisting of polyalkylene terephthalates, polyalkylene naphthalates, polyamides, polyolefins, polyacrylonitrile, and combinations thereof. In a particular embodiment, the fiber comprises a polymer selected from the group consisting of polyethylene terephthalate (PET), polybutylene terephthalate, polyamide and acrylic. In another particular embodiment, the organic fiber comprises PET.

In one embodiment, the fiber is a single component fiber. In another embodiment, the fiber is a multicomponent fiber wherein the fiber is formed from a process wherein at least two polymers are extruded from separate extruders and meltblown or spun together to form one fiber. In a particular aspect of this embodiment, the polymers used in the multicomponent fiber are substantially the same. In another particular aspect of this embodiment, the polymers used in the multicomponent fiber are different from each other. The configuration of the multicomponent fiber can be, for example, a sheath/core arrangement, a side-by-side arrangement, a pie arrangement, an islands-in-the-sea arrangement, or a variation thereof. The fiber may also be drawn to enhance mechanical properties via orientation, and subsequently annealed at elevated temperatures, but below the crystalline melting point to reduce shrinkage and improve dimensional stability at elevated temperature.

The length and diameter of the fiber employed in the fiber reinforced polypropylene composite headliner substrate panels contemplated herein are not particularly restricted. In a particular embodiment, the fibers have a length of ¼ inch, or a length within the range having a lower limit of ⅛ inch, or ⅙ inch, and an upper limit of ⅓ inch, or ½ inch. In another particular embodiment, the diameter of the fibers is within the range having a lower limit of 10 μm and an upper limit of 100 μm.

The fiber may further contain additives commonly known in the art, such as dispersants, lubricants, flame-retardants, antioxidants, antistatic agents, light stabilizers, ultraviolet light absorbers, carbon black, nucleating agents, plasticizers, and coloring agents, such as dyes or pigments.

The fiber used in the fiber reinforced polypropylene composite headliner substrate panels contemplated herein is not limited by any particular fiber form. For example, the fiber can be in the form of continuous filament yarn, partially oriented yarn, or staple fiber. In another embodiment, the fiber may be a continuous multifilament fiber or a continuous monofilament fiber.

The compositions employed in the fiber reinforced polypropylene composite headliner substrate panels contemplated herein optionally include inorganic filler in an amount of at least 1 wt %, or at least 5 wt %, or at least 10 wt %, or in an amount within the range having a lower limit of 0 wt %, or 1 wt %,or 5 wt %, or 10 wt %, or 15 wt %, and an upper limit of 25 wt %, or 30 wt or 35 wt %, or 40 wt %, based on the total weight of the composition. In yet another embodiment, the inorganic filler may be included in the polypropylene fiber composite in the range of from 10 wt % to about 60 wt %. In a particular embodiment, the inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, magnesium oxysulfate, titanium oxide, zinc oxide, zinc sulfate, and combinations thereof. The talc may have a size of from about 1 to about 100 microns.

Preferred for use in the compositions employed in the fiber reinforced polypropylene composite headliner substrate panels contemplated herein is high aspect ratio talc. Although aspect ratio can be calculated by dividing the average particle diameter of the talc by the average thickness using a conventional microscopic method, this is a difficult and tedious technique. A particularly useful indication of aspect ratio is known in the art as “lamellarity index,” which is a ratio of particle size measurements. Therefore, as used herein, by “high aspect ratio” talc is meant talc having an average lamellarity index greater than or equal to about 4 or greater than or equal to about 5. Exemplary talc may have a specific surface area B.E.T of at least about 14 square meters/gram or at least about 16 square meters/gram, as measured using DIN 66131/2. With regard to particle size distribution, exemplary talc may have a value of d50 of at least about 2 μm and a value of d95 of at least about 10 μm, as measured using a Sedigraph 5100 and a d50 of at least about 11 μm, as measured using a Laser Malvern Mastersizer.

In one particular embodiment, at a high talc loading of up to about 60 wt %, the polypropylene fiber composite exhibited a flexural modulus of at least about 750,000 psi and no splintering during instrumented impact testing (15 mph, −29° C. and 25 lbs). In another particular embodiment, at low talc loading of as low as 10 wt %, the polypropylene fiber composite exhibited a flexural modulus of at least about 325,000 psi and no splintering during instrumented impact testing (15 mph, −29° C. and 25 lbs). In addition, wollastonite loadings of from 5 wt % to 60 wt % in the polypropylene fiber composite yielded an outstanding combination of impact resistance and stiffness.

In another particular embodiment, a fiber reinforced polypropylene composition including a polypropylene based resin with a melt flow rate of 80 to 1500, 10 to 15 wt % of polyester fiber, and 50 to 60 wt % of inorganic filler displayed a flexural modulus of 850,000 to 1,200,000 psi and did not shatter during instrumented impact testing at −29 degrees centigrade, tested at 25 pounds and 15 miles per hour. The inorganic filler includes, but is not limited to, talc and wollastonite. This combination of stiffness and toughness is difficult to achieve in a polymeric based material. In addition, the fiber reinforced polypropylene composition has a heat distortion temperature at 66 psi of greater than 100 degrees centigrade, and a flow and cross flow coefficient of linear thermal expansion of 2.2×10⁻⁵ and 3.3×10⁻⁵ per degree centigrade respectively. In comparison, rubber toughened polypropylene has a heat distortion temperature of 94.6 degrees centigrade, and a flow and cross flow thermal expansion coefficient of 10×10⁻⁵ and 18.6×10⁻⁵ per degree centigrade respectively.

Composite headliner substrate panels of the present invention are made by forming the fiber-reinforced polypropylene composition, extruding the composition into sheet form and then thermoforming the composition to form the headliner substrate panel. The invention is not limited by any particular method of forming the compositions. For example, the compositions can be formed by contacting polypropylene, organic fiber, and optional inorganic filler in any of the well known processes of pultrusion or extrusion compounding. In a particular embodiment, the compositions are formed in an extrusion compounding process. In a particular aspect of this embodiment, the organic fibers are cut prior to being placed in the extruder hopper. In another particular aspect of this embodiment, the organic fibers are fed directly from one or more spools into the extruder hopper.

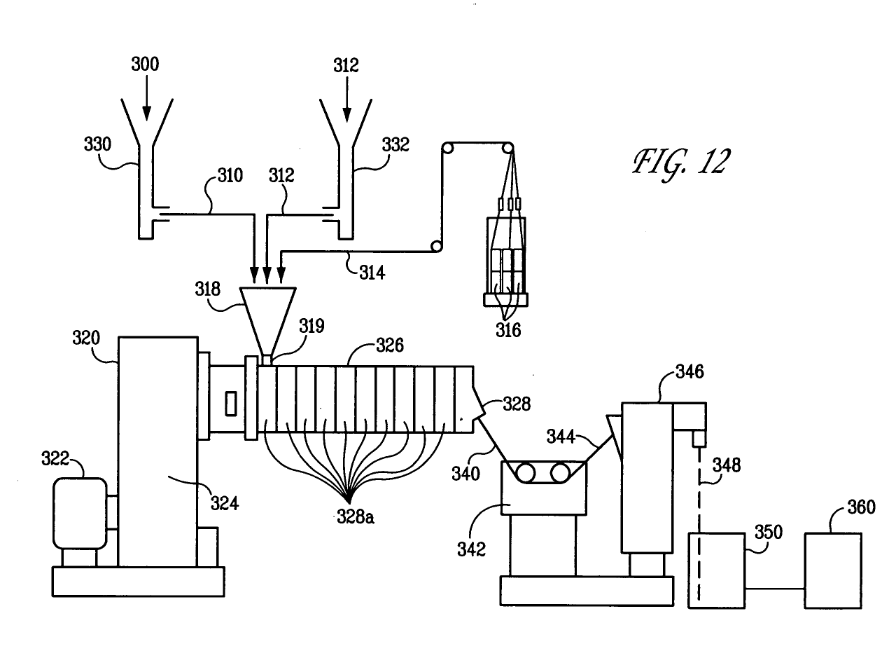

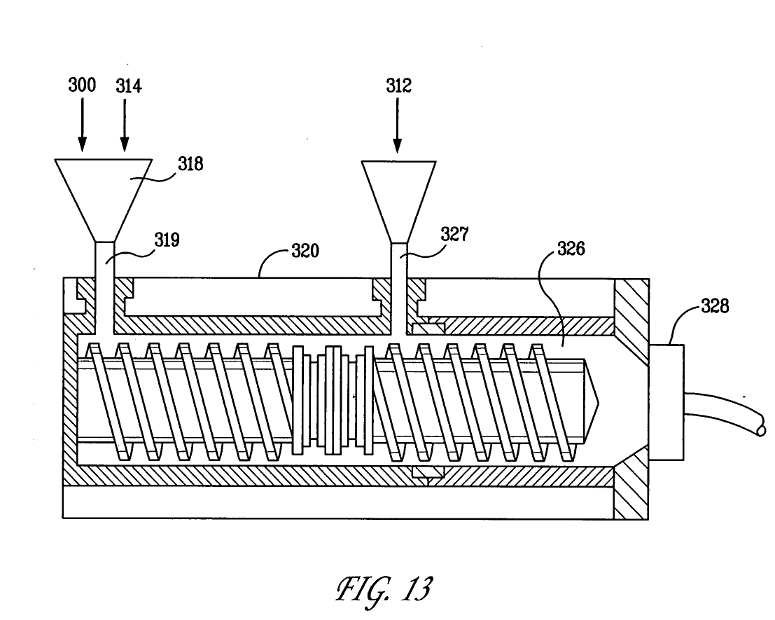

Referring now to FIG. 12, an exemplary schematic of the process for making fiber reinforced polypropylene composites of the instant invention is shown. Polypropylene based resin 300, inorganic filler 312, and organic fiber 314 continuously unwound from one or more spools 316 are fed into the extruder hopper 318 of a twin screw compounding extruder 320. The extruder hopper 318 is positioned above the feed throat 319 of the twin screw compounding extruder 320. The extruder hopper 318 may alternatively be provided with an auger (not shown) for mixing the polypropylene based resin 300 and the inorganic filler 312 prior to entering the feed throat 319 of the twin screw compounding extruder 320. In an alternative embodiment, as depicted in FIG. 13, the inorganic filler 312 may be fed to the twin screw compounding extruder 320 at a downstream feed port 327 in the extruder barrel 326 positioned downstream of the extruder hopper 318 while the polypropylene based resin 300 and the organic fiber 314 are still metered into the extruder hopper 318.

Referring again to FIG. 12, the polypropylene based resin 300 is metered to the extruder hopper 318 via a feed system 330 for accurately controlling the feed rate. Similarly, the inorganic filler 312 is metered to the extruder hopper 318 via a feed system 332 for accurately controlling the feed rate. The feed systems 330 and 332 may be, but are not limited to, gravimetric feed system or volumetric feed systems. Gravimetric feed systems are particularly preferred for accurately controlling the weight percentage of polypropylene based resin 300 and inorganic filler 312 being fed to the extruder hopper 318. The feed rate of organic fiber 314 to the extruder hopper 318 is controlled by a combination of the extruder screw speed, number of fiber filaments and the thickness of each filament in a given fiber spool, and the number of fiber spools 316 being unwound simultaneously to the extruder hopper 318. The higher the extruder screw speed measured in revolutions per minute (rpm), the greater will be the rate at which organic fiber 314 is fed to the twin screw compounding screw 320. The rate at which organic fiber 314 is fed to the extruder hopper also increases with the greater the number of filaments within the organic fiber 314 being unwound from a single fiber spool 316, the greater filament thickness, the greater the number fiber spools 316 being unwound simultaneously, and the rotations per minute of the extruder.

The twin screw compounding extruder 320 includes a drive motor 322, a gear box 324, an extruder barrel 326 for holding two screws (not shown), and a strand die 328. The extruder barrel 326 is segmented into a number of heated temperature controlled zones 328a. As depicted in FIG. 12, the extruder barrel 326 includes a total of ten temperature control zones 328a. The two screws within the extruder barrel 326 of the twin screw compounding extruder 320 may be intermeshing or non-intermeshing, and may rotate in the same direction (co-rotating) or rotate in opposite directions (counter-rotating). From a processing perspective, the melt temperature must be maintained above that of the polypropylene based resin 300, and far below the melting temperature of the organic fiber 314, such that the mechanical properties imparted by the organic fiber will be maintained when mixed into the polypropylene based resin 300. In one exemplary embodiment, the barrel temperature of the extruder zones did not exceed 154° C. when extruding PP homopolymer and PET fiber, which yielded a melt temperature above the melting point of the PP homopolymer, but far below the melting point of the PET fiber. In another exemplary embodiment, the barrel temperatures of the extruder zones are set at 185° C. or lower.

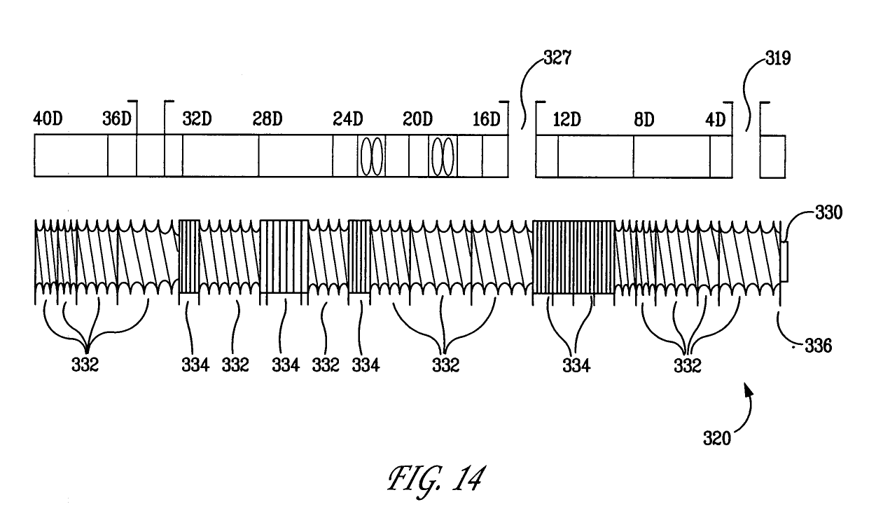

An exemplary schematic of a twin screw compounding extruder 320 screw configuration for making fiber reinforced polypropylene composites is depicted in FIG. 14. The feed throat 319 allows for the introduction of polypropylene based resin, organic fiber, and inorganic filler into a feed zone of the twin screw compounding extruder 320. The inorganic filler may be optionally fed to the extruder 320 at the downstream feed port 327. The twin screws 330 include an arrangement of interconnected screw sections, including conveying elements 332 and kneading elements 334. The kneading elements 334 function to melt the polypropylene based resin, cut the organic fiber lengthwise, and mix the polypropylene based melt, chopped organic fiber and inorganic filler to form a uniform blend. More particularly, the kneading elements function to break up the organic fiber into about ⅛ inch to about 1 inch fiber lengths. A series of interconnected kneading elements 334 is also referred to as a kneading block. U.S. Pat. No. 4,824,256 to Haring, et al., herein incorporated by reference in its entirety, discloses co-rotating twin screw extruders with kneading elements. The first section of kneading elements 334 located downstream from the feed throat is also referred to as the melting zone of the twin screw compounding extruder 320. The conveying elements 332 function to convey the solid components, melt the polypropylene based resin, and convey the melt mixture of polypropylene based polymer, inorganic filler and organic fiber downstream toward the strand die 328 (see FIG. 13) at a positive pressure.

The position of each of the screw sections as expressed in the number of diameters (D) from the start 336 of the extruder screws 330 is also depicted in FIG. 14. The extruder screws in FIG. 14 have a length to diameter ratio of 40/1, and at a position 32D from the start 336 of screws 330, there is positioned a kneading element 334. The particular arrangement of kneading and conveying sections is not limited to that as depicted in FIG. 14, however one or more kneading blocks consisting of an arrangement of interconnected kneading elements 334 may be positioned in the twin screws 330 at a point downstream of where organic fiber and inorganic filler are introduced to the extruder barrel. The twin screws 330 may be of equal screw length or unequal screw length. Other types of mixing sections may also be included in the twin screws 3230, including, but not limited to, Maddock mixers, and pin mixers.

Referring once again to FIG. 12, the uniformly mixed fiber reinforced polypropylene composite melt comprising polypropylene based polymer 300, inorganic filler 312, and organic fiber 314 is metered by the extruder screws to a strand die 328 for forming one or more continuous strands 340 of fiber reinforced polypropylene composite melt. The one or more continuous strands 340 are then passed into water bath 342 for cooling them below the melting point of the fiber reinforced polypropylene composite melt to form solid fiber reinforced polypropylene composite strands 344. The water bath 342 is typically cooled and controlled to a constant temperature much below the melting point of the polypropylene based polymer. The solid fiber reinforced polypropylene composite strands 344 are then passed into a pelletizer or pelletizing unit 346 to cut them into fiber reinforced polypropylene composite resin 348 measuring from about ¼ inch to about 1 inch in length. The fiber reinforced polypropylene composite resin 348 may then be accumulated in containers 350 and either alternatively conveyed to silos for storage or conveyed to sheet extruding and/or thermoforming line 360.

The present invention is further illustrated by means of the following examples and the advantages thereto without limiting the scope thereof.

Test Methods

Fiber reinforced polypropylene compositions described herein were injection molded at 2300 psi pressure, 401° C. at all heating zones as well as the nozzle, with a mold temperature of 60° C.

Flexural modulus data was generated for injected molded samples produced from the fiber reinforced polypropylene compositions described herein using the ISO 178 standard procedure.

Instrumented impact test data was generated for injected mold samples produced from the fiber reinforced polypropylene compositions described herein using ASTM D3763. Ductility during instrumented impact testing (test conditions of 15 mph, −29° C., and 25 lbs) is defined as no splintering of the sample.

### EXAMPLES

PP3505G is a propylene homopolymer commercially available from ExxonMobil Chemical Company of Baytown, Tex. The MFR (2.16 kg, 230° C.) of PP3505G was measured according to ASTM D1238 to be 400 g/10 min.

PP7805 is an 80 MFR propylene impact copolymer commercially available from ExxonMobil Chemical Company of Baytown, Tex.

PP8114 is a 22 MFR propylene impact copolymer containing ethylene-propylene rubber and a plastomer, and is commercially available from ExxonMobil Chemical Company of Baytown, Tex.

PP8224 is a 25 MFR propylene impact copolymer containing ethylene-propylene rubber and a plastomer, and is commercially available from ExxonMobil Chemical Company of Baytown, Tex.

PO1020 is 430 MFR maleic anhydride functionalized polypropylene homopolymer containing 0.5-1.0 weight percent maleic anhydride.

Cimpact CB7 is a surface modified talc, V3837 is a high aspect ratio talc, and Jetfine 700 C is a high surface area talc, all available from Luzenac America Inc. of Englewood, Colo.

### Illustrative Examples 1-8

Varying amounts of PP3505G and 0.25″ long polyester fibers obtained from Invista Corporation were mixed in a Haake single screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact under standard automotive conditions for interior parts (25 lbs, at 15 MPH, at −29° C.). The total energy absorbed and impact results are given in Table 1.

TABLE 1

| | Wt % | Wt % | Total Energy | Instrumented |
|---|---|---|---|---|
| Example # | PP3505G | Fiber | (ft-lbf) | Impact Test Results |
| 1 | 65 | 35 | 8.6 ± 1.1 | ductile* |
| 2 | 70 | 30 | 9.3 ± 0.6 | ductile* |
| 3 | 75 | 25 | 6.2 ± 1.2 | ductile* |
| 4 | 80 | 20 | 5.1 ± 1.2 | ductile* |
| 5 | 85 | 15 | 3.0 ± 0.3 | ductile* |
| 6 | 90 | 10 | 2.1 ± 0.2 | ductile* |
| 7 | 95 | 5 | 0.4 ± 0.1 | brittle** |
| 8 | 100 | 0 | <0.1 | brittle*** |

*Examples 1-6: samples did not shatter or split as a result of impact, with no pieces coming off of the specimen.
**Example 7: pieces broke off of the sample as a result of the impact
***Example 8: samples completely shattered as a result of impact.

### Illustrative Examples 9-14

In Examples 9-11, 35 wt % PP7805, 20 wt % Cimpact CB7 talc, and 45 wt % 0.25″ long polyester fibers obtained from Invista Corporation, were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact. The total energy absorbed and impact results are given in Table 2.

In Examples 12-14, PP8114 was extruded and molded under the same conditions as those for Examples 9-11. The total energy absorbed and impact results are given in Table 2.

TABLE 2

| | | | |
|---|---|---|---|
| | | | Instrumented |
| Exam- | Impact Conditions/Applied | Total Energy | Impact Test |
| ple # | Energy | (ft-lbf) | Results |

35 wt % PP7805 (70 MFR), 20 wt % talc, 45 wt % fiber

| | | | |
|---|---|---|---|
| 9 | −29° C., 15 MPH, 25 lbs/192 ft-lbf | 16.5 | ductile* |
| 10 | −29° C., 28 MPH, 25 lbs/653 ft-lbf | 14.2 | ductile* |
| 11 | −29° C., 21 MPH, 58 lbs/780 ft-lbf | 15.6 | ductile* |

100 wt % PP8114 (22 MFR)

| | | | |
|---|---|---|---|
| 12 | −29° C., 15 MPH, 25 lbs/192 ft-lbf | 32.2 | ductile* |
| 13 | −29° C., 28 MPH, 25 lbs/653 ft-lbf | 2.0 | brittle** |
| 14 | −29° C., 21 MPH, 58 lbs/780 ft-lbf | 1.7 | brittle** |

*Examples 9-12: samples did not shatter or split as a result of impact, with no pieces coming off of the specimen.
**Examples 13-14: samples shattered as a result of impact.

### Illustrative Examples 15-16

A Leistritz ZSE27 HP-60D 27 mm twin screw extruder with a length to diameter ratio of 40:1 was fitted with six pairs of kneading elements 12″ from the die exit to form a kneading block. The die was ¼″ in diameter. Strands of continuous 27,300 denier PET fibers were fed directly from spools into the hopper of the extruder, along with PP7805 and talc. The kneading elements in the kneading block in the extruder broke up the fiber in situ. The extruder speed was 400 revolutions per minute, and the temperatures across the extruder were held at 190° C. Molding was done under conditions similar to those described for Examples 1-14. The mechanical and physical properties of the sample were measured and are compared in Table 3 with the mechanical and physical properties of PP8224.

The instrumented impact test showed that in both examples there was no evidence of splitting or shattering, with no pieces coming off the specimen. In the notched charpy test, the PET fiber-reinforced PP7805 specimen was only partially broken, and the PP8224 specimen broke completely.

TABLE 3

| | Example 15 | |
|---|---|---|
| Test | PET fiber-reinforced | Example 16 |
| (Method) | PP7805 with talc | PP8224 |
| Flexural Modulus, Chord | 525,190 psi | 159,645 psi |
| (ISO 178) | | |
| Instrumented Impact at −30° C. | 6.8 J | 27.5 J |
| Energy to maximum load | | |
| 100 lbs at 5 MPH | | |
| (ASTM D3763) | | |
| Notched Charpy Impact at | 52.4 kJ/m² | 5.0 kJ/m² |
| −40° C. | | |
| (ISO 179/1eA) | | |
| Heat Deflection Temperature | 116.5° C. | 97.6° C. |
| at 0.45 Mpa, edgewise | | |
| (ISO 75) | | |
| Coefficient of Linear Thermal | 2.2/12.8 | 10.0/18.6 |
| Expansion, −30° C. to 100° C., | (E-5/° C.) | (E-5/° C.) |
| Flow/Crossflow | | |
| (ASTM E831) | | |

### Illustrative Examples 17-18

In Examples 17-18, 30 wt % of either PP3505G or PP8224, 15 wt % 0.25″ long polyester fibers obtained from Invista Corporation, and 45 wt % V3837 talc were mixed in a Haake twin screw extruder at 175° C. The strand that exited the extruder was cut into 0.5″ lengths and molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 4.

TABLE 4

| | | | Instrumented Impact |
|---|---|---|---|
| | | | at −30° C. |
| | | | Energy to maximum |
| | | Flexural Modulus, | load |
| | | Chord, psi | 25 lbs at 15 MPH |
| Example | Polypropylene, | (ISO 178) | (ASTM D3763), ft-lb |
| 17 | PP8224 | 433840 | 2 |
| 18 | PP3505 | 622195 | 2.9 |

The rubber toughened PP8114 matrix with PET fibers and talc displayed lower impact values than the PP3505 homopolymer. This result is surprising, because the rubber toughened matrix alone is far tougher than the low molecular weight PP3505 homopolymer alone at all temperatures under any conditions of impact. In both examples above, the materials displayed no splintering.

### Illustrative Examples 19-24

In Examples 19-24, 25-75 wt % PP3505G, 15 wt % 0.25″ long polyester fibers obtained from Invista Corporation, and 10-60 wt % V3837 talc were mixed in a Haake twin screw extruder at 175° C. The strand that exited the extruder was cut into 0.5″ lengths and molded using a Boy 50M ton molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 5.

TABLE 5

| | | Flexural Modulus, |
|---|---|---|
| Example | Talc Composition, | Chord, psi (ISO 178) |
| 19 | 10% | 273024 |
| 20 | 20% | 413471 |
| 21 | 30% | 583963 |
| 22 | 40% | 715005 |
| 23 | 50% | 1024394 |
| 24 | 60% | 1117249 |

It is important to note that in Examples 19-24, the samples displayed no splintering in drop weight testing at an −29° C., 15 miles per hour at 25 pounds.

### Illustrative Examples 25-26

Two materials, one containing 10% ¼ inch polyester fibers, 35% PP3505 polypropylene and 60% V3837 talc (example 25), the other containing 10% ¼ inch polyester fibers, 25% PP3505 polypropylene homopolymer (example 26), 10% P01020 modified polypropylene were molded in a Haake twin screw extruder at 175° C. They were molded into standard ASTM A370 ½ inch wide sheet type tensile specimens. The specimens were tested in tension, with a ratio of minimum to maximum load of 0.1, at flexural stresses of 70 and 80% of the maximum stress.

TABLE 6

| Percentage of | | |
|---|---|---|
| Maximum Stress to | Example 25, | Example 26, |
| Yield Point | Cycles to failure | Cycles to failure |
| 70 | 327 | 9848 |
| 80 | 30 | 63 |

The addition of the modified polypropylene is shown to increase the fatigue life of these materials.

### Illustrative Examples 27-29

A Leistritz 27 mm co-rotating twin screw extruder with a ratio of length to diameter of 40:1 was used in these experiments. The process configuration utilized was as depicted in FIG. 12. The screw configuration used is depicted in FIG. 14, and includes an arrangement of conveying and kneading elements. Talc, polypropylene and PET fiber were all fed into the extruder feed hopper located approximately two diameters from the beginning of the extruder screws (319 in the FIG. 14). The PET fiber was fed into the extruder hopper by continuously feeding from multiple spools a fiber tow of 3100 filaments with each filament having a denier of approximately 7.1. Each filament was 27 microns in diameter, with a specific gravity of 1.38.

The twin screw extruder ran at 603 rotations per minute. Using two gravimetric feeders, PP7805 polypropylene was fed into the extruder hopper at a rate of 20 pounds per hour, while CB 7 talc was fed into the extruder hopper at a rate of 15 pounds per hour. The PET fiber was fed into the extruder at 12 pounds per hour, which was dictated by the screw speed and tow thickness. The extruder temperature profile for the ten zones 144° C. for zones 1-3, 133° C. for zone 4, 154° C. for zone 5, 135° C. for zone 6, 123° C. for zones 7-9, and 134° C. for zone 10. The strand die diameter at the extruder exit was ¼ inch.

The extrudate was quenched in an 8 foot long water trough and pelletized to ½ inch length to form PET/PP composite pellets. The extrudate displayed uniform diameter and could easily be pulled through the quenching bath with no breaks in the water bath or during instrumented impact testing. The composition of the PET/PP composite pellets produced was 42.5 wt % PP, 25.5 wt % PET, and 32 wt % talc.

The PET/PP composite resin produced was molded and displayed the following properties:

TABLE 7

| | Example 27 |
|---|---|
| Specific Gravity | 1.3 |
| Tensile Modulus, Chord @ 23° C. | 541865 psi |
| Tensile Modulus, Chord @ 85° C. | 257810 psi |
| Flexural Modulus, Chord @ 23° C. | 505035 psi |
| Flexural Modulus, Chord @ 85° C. | 228375 psi |
| HDT @ 0.45 MPA | 116.1° C. |
| HDT @ 1.80 MPA | 76.6° C. |
| Instrumented impact @ 23° C. | 11.8 J D** |
| Instrumented impact @ −30° C. | 12.9 J D** |

**Ductile failure with radial cracks

In Example 28, the same materials, composition, and process set-up were utilized, except that extruder temperatures were increased to 175° C. for all extruder barrel zones. This material showed complete breaks in the instrumented impact test both at 23° C. and −30° C. Hence, at a barrel temperature profile of 175° C., the mechanical properties of the PET fiber were negatively impacted during extrusion compounding such that the PET/PP composite resin had poor instrumented impact test properties.

In Example 29, the fiber was fed into a hopper placed 14 diameters down the extruder (327 in the FIG. 14). In this case, the extrudate produced was irregular in diameter and broke an average once every minute as it was pulled through the quenching water bath. When the PET fiber tow is continuously fed downstream of the extruder hopper, the dispersion of the PET in the PP matrix was negatively impacted such that a uniform extrudate could not be produced, resulting in the irregular diameter and extrudate breaking.

### Illustrative Example 30

An extruder with the same size and screw design as Examples 27-29 was used. All zones of the extruder were initially heated to 180° C. PP 3505 dry mixed with Jetfine 700 C and PO 1020 was then fed at 50 pounds per hour using a gravimetric feeder into the extruder hopper located approximately two diameters from the beginning of the extruder screws. Polyester fiber with a denier of 7.1 and a thickness of 3100 filaments was fed through the same hopper. The screw speed of the extruder was then set to 596 revolutions per minute, resulting in a feed rate of 12.1 pounds of fiber per hour. After a uniform extrudate was attained, all temperature zones were lowered to 120° C., and the extrudate was pelletized after steady state temperatures were reached. The final composition of the blend was 48% PP 3505, 29.1% Jetfine 700 C, 8.6% PO 1020 and 14.3% polyester fiber.

The PP composite resin produced while all temperature zones of the extruder were set to 120° C. was injection molded and displayed the following properties:

TABLE 8

| | Example 30 |
|---|---|
| Flexural Modulus, Chord @ 23° C. | 467,932 psi |
| Instrumented impact @ 23° C. | 8.0 J D** |
| Instrumented impact @ −30° C. | 10.4 J D** |

**Ductile failure with radial cracks

All patents, test procedures, and other documents cited herein, including priority documents, are fully incorporated by reference to the extent such disclosure is not inconsistent with this invention and for all jurisdictions in which such incorporation is permitted.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the invention, including all features which would be treated as equivalents thereof by those skilled in the art to which the invention pertains.

When numerical lower limits and numerical upper limits are listed herein, ranges from any lower limit to any upper limit are contemplated.

What is claimed is:

1. A fiber reinforced composite headliner substrate panel, said headliner substrate panel molded from a composition comprising at least 30 wt % polypropylene based resin, from 10 to 60 wt % organic fiber and from 0 to 40 wt % inorganic filler, based on the total weight of the composition, said headliner substrate panel having an outer surface and an underside surface.

2. The fiber reinforced composite headliner substrate panel of claim 1, wherein said polypropylene based resin is selected from the group consisting of polypropylene homopolymers, propylene-ethylene random copolymers, propylene-α-olefin random copolymers, propylene impact copolymers, and combinations thereof.

3. The fiber reinforced composite headliner substrate panel of claim 2, wherein said polypropylene based resin is polypropylene homopolymer with a melt flow rate of from about 20 to about 1500 g/10 minutes.

4. The fiber reinforced composite headliner substrate panel of claim 1, wherein said polypropylene based resin further comprises from about 0.1 wt % to less than about 10 wt % of a polypropylene based polymer modified with a grafting agent, wherein said grafting agent is selected from the group consisting of acrylic acid, methacrylic acid, maleic acid, itaconic acid, fumaric acid or esters thereof, maleic anhydride, itaconic anhydride, and combinations thereof.

5. The fiber reinforced composite headliner substrate panel of claim 1, wherein said composition further comprises from 0 to 0.1 wt % lubricant, based on the total weight of the composition.

6. The fiber reinforced composite headliner substrate panel of claim 5, wherein said lubricant is selected from the group consisting of silicon oil, silicon gum, fatty amide, paraffin oil, paraffin wax, and ester oil.

7. The fiber reinforced composite headliner substrate panel of claim 1, wherein said organic fiber is selected from the group consisting of polyalkylene terephthalates, polyalkylene naphthalates, polyamides, polyolefins, polyacrylonitrile, and combinations thereof.

8. The fiber reinforced composite headliner substrate panel of claim 7, wherein said organic fiber is polyethylene terephthalate.

9. The fiber reinforced composite headliner substrate panel of claim 1, wherein said inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

10. The fiber reinforced composite headliner substrate panel of claim 9, wherein said inorganic filler is talc or wollastonite.

11. The fiber reinforced composite headliner substrate panel of claim 1, wherein said headliner substrate panel has a flexural modulus of at least 300,000 psi and exhibits ductility during instrumented impact testing.

12. The fiber reinforced composite headliner substrate panel of claim 1, wherein said headliner substrate panel has a flexural modulus of at least 400,000 psi, and exhibits ductility during instrumented impact testing.

13. The fiber reinforced composite headliner substrate panel of claim 1, wherein said headliner substrate panel exhibits a hinge-effect upon impact loading.

14. The fiber reinforced composite headliner substrate panel of claim 1, wherein said composite headliner substrate panel is installed in a vehicle to conceal at least one overhead airbag assembly.

15. The fiber reinforced composite headliner substrate panel of claim 14, wherein said composite headliner substrate panel conceals driver and passenger side overhead airbag assemblies.

16. The fiber reinforced composite headliner substrate panel of claim 1, wherein said composite headliner substrate panel is provided with a lateral channel formed in a forward portion of the underside surface of the composite headliner substrate panel.

17. The fiber reinforced composite headliner substrate panel of claim 16, wherein said composite headliner substrate panel has a forward edge and peripheral edges, wherein said channel, said forward edge and a portion of said peripheral edges that lie forward of said channel cooperate to form an overhead airbag door.

18. The fiber reinforced composite headliner substrate panel of claim 1, wherein said composite headliner substrate panel is thermoformed from an extruded multilayer composite sheet, said outer surface including a fabric bottom cover to substantially match an interior surface of a vehicle.

19. The fiber reinforced composite headliner substrate panel of claim 1, wherein at least said outer surface of said composite headliner substrate panel is provided with a class A surface finish.

20. A process for producing a fiber reinforced composite headliner substrate panel for a vehicle, the process comprising the step of molding a composition to form the fiber reinforced composite headliner substrate panel, the fiber reinforced composite headliner substrate panel having at least an outer surface and an underside surface, wherein the composition comprises at least 30 wt % polypropylene, from 10 to 60 wt % organic fiber and from 0 to 40 wt % inorganic filler, based on the total weight of the composition.

21. The process of claim 20, wherein the composite headliner substrate panel has a flexural modulus of at least 300,000 psi and exhibits ductility during instrumented impact testing.

22. The process of claim 20, wherein the composition is formed by a step comprising extrusion compounding to form an extrudate.

23. The process of claim 22, wherein the organic fiber is cut prior to the extrusion compounding step.

24. The process of claim 22, wherein during the extrusion compounding step, the organic fiber is a continuous fiber and is fed directly from one or more spools into an extruder hopper.

25. The process of claim 20, wherein the composite headliner substrate panel is installed in the vehicle to conceal at least one overhead airbag assembly.

26. The process of claim 20, further comprising the step of providing a lateral channel formed in a forward portion of the underside surface of the composite headliner substrate panel.

27. The process of claim 26, wherein the composite headliner substrate panel has a forward edge and peripheral edges, wherein the channel, said forward edge and a portion of said peripheral edges that lie forward of the channel cooperate to form an overhead airbag door.

28. The process of claim 20, wherein the composite headliner substrate panel is thermoformed from an extruded multilayer composite sheet, the outer surface including a fabric bottom cover to substantially match an interior surface of the vehicle.

29. The process of claim 20, wherein the composite headliner substrate panel exhibits a “hinge-effect” upon impact loading.

30. The process of claim 20, further comprising the step of providing at least the outer surface of the composite headliner substrate panel with a class A surface finish.

31. A process for making a fiber reinforced polypropylene composite headliner substrate panel, comprising the following steps:
(a) feeding into a twin screw extruder hopper at least about 25 wt % of a polypropylene based resin with a melt flow rate of from about 20 to about 1500 g/10 minutes;
(b) continuously feeding by unwinding from one or more spools into the twin screw extruder hopper from about 5 wt % to about 40 wt % of an organic fiber;
(c) feeding into a twin screw extruder from about 10 wt % to about 60 wt % of an inorganic filler;
(d) extruding the polypropylene based resin, the organic fiber, and the inorganic filler through the twin screw extruder to form a fiber reinforced polypropylene composite melt;
(e) cooling the fiber reinforced polypropylene composite melt to form a solid fiber reinforced polypropylene composite; and
(f) molding the fiber reinforced polypropylene composite to form the composite headliner substrate panel, the composite headliner substrate panel, having an outer surface and an underside surface.

32. The process of claim 31, wherein the fiber reinforced polypropylene composite headliner substrate panel has a flexural modulus of at least about 300,000 psi and exhibits ductility during instrumented impact testing.

33. The process of claim 31, wherein the polypropylene based resin is selected from the group consisting of polypropylene homopolymers, propylene-ethylene random copolymers, propylene-α-olefin random copolymers, propylene impact copolymers, and combinations thereof.

34. The process of claim 31, wherein the organic fiber is selected from the group consisting of polyalkylene terephthalates, polyalkylene naphthalates, polyamides, polyolefins, polyacrylonitrile, and combinations thereof.

35. The process of claim 34, wherein the organic fiber is polyethylene terephthalate.

36. The process of claim 31, wherein the inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

37. The process of claim 36, wherein the inorganic filler is talc or wollastonite.

38. The process of claim 31, wherein said step of feeding the inorganic filler into the twin screw extruder further comprises feeding the inorganic filler into the twin screw extruder hopper via a gravimetric feed system or feeding the inorganic filler into the twin screw extruder at a downstream injection port via a gravimetric feed system.

39. The process of claim 31, wherein said step of cooling the fiber reinforced polypropylene composite melt to form a solid fiber reinforced polypropylene composite is by continuously passing strands of the fiber reinforced polypropylene composite melt through a cooled water bath.

40. The process of claim 31, further comprising the step of:
(g) providing a lateral channel formed in an upper portion of the composite headliner substrate panel.
